(19) United States
(12) Patent Application Publication
(10) Pub. No.: US 2010/0326770 A1
(43) Pub. Date: Dec. 30, 2010

(54) ACCESSORY MOUNTING

(76) Inventor: Adam Brooks Clifford, Co. Down (GB)

Correspondence Address: Adam Clifford, 7 Bayview Drive, Co. Down, BT 30 7TJ, IE

(21) Appl. No.: 12/451,189

(22) PCT Filed: Jul. 12, 2007
(86) PCT No.: PCT/GB2007/004701

§ 371 Date: Oct. 29, 2009

(30) Foreign Application Priority Data
Dec. 7, 2006 (GB) 0624398.4

(51) Int. Cl. E06C 7/48

(52) U.S. Cl. 182/214

(57) ABSTRACT

The accessory mounting comprises a securable attachment device, principally front-loading, comprising two horizontally connected pairs of vertically (with respect to a standing ladder) connected and extendible diverging rung-gripping hooks, incorporating a horizontal member, the mid-section of a toolbar with attached arms extending into the horizontal (26b, 26c, 2[iii], 14a). Struts (18) stemming from the attachment device (Ia, 27d) connect with a cross-member joining the arms (14a, 18, 18a, 17, 17a) which have the means to co-jointly mount adapted ladder accessories (14e). To maximise functionality, the arms can vertically rotate selectively within the horizontal plane of a standing ladder, with a capacity for limited free rotation (2 [iii], 15d, 15c), project into the horizontal at selected angles (14), and are adjustably extendable (14a, 14e), the toolbar shortened (2 [iii], 2[i]a, 2[i]b], the struts extendable and pivotal (18, 18b, 18c, 18d, 18e) and the cross-member (17, 17a) extendable. The apparatus has a centering mechanism (3). The apparatus can be stored in a toolbox which converts into a work surface and loading trestle.

### TECHNICAL FIELD

The present invention relates to the accessorising of ladders.

### BACKGROUND ART

Ladders are an available expedient means for accessing work at heights.

Accessories can significantly contribute to the effective functioning of ladders, increase stabilised access to work, facilitate work activity, and further exploit the access potential of ladders. However the use of accessories in terms of their attachment, handling, transport and storage, both on and off ladders, can seem cumbersome compared to the sheer expediency of ladders. This makes them less likely to be used.

The present invention arises out of three considerations to facilitate their use.

The first is the secure, universal, expeditious attachment of accessories to both faces of ladders.

The second is to significantly facilitate their application, in terms of handling, transport and storage, both on and off ladders.

The third consideration is to further facilitate their use by the use of a toolbar which can be readily accessorised with a diverse range of ladder tools, such as a stabiliser, stand-off or base, a roof-ridge attachment, a hedge-clipping attachment, extensions to convert the ladder into step-ladders, a work-surface, a tool for use on delicate surfaces such as slate or glass, the means to be employed with step-ladders, lending increased utility to ladders, and thereby increasing the value, and perhaps the perception, of accessories as multi-tasking assets in the use of ladders.

The back ground art is replete with accessories for various purposes, which then can, by extension, perform other functions.

Below are some examples of background art that address accessories.

### WO 83/02796 A1

(SMITH)

### GB 2182086 A

(SAFETYMATE, LADDER).

U.S. Pat. No. 5,855,252 A

(VROLYKS)

### GB 2305458 A

(ELLIOT et al)

### DE 29804720 U

### BE 1010158 A6

(DONVIL).

### FR 2745030 A1

(PELOFI)

### FR 2716491 A

(REY)

### DE 29804720 U

(LAUG)

The present invention addresses not so much the application, but the method and/or mechanism of application, proposing an apparatus that structurally articulates necessary requirements. Here accessories are developed to particularly answer the needs of a task, which can then be adapted to attach to the apparatus. This simplifies ladder-based resolutions in the context of accessories. The proposed scenario associated with the invention, is that a universal accessory mounting apparatus, constituting an accessory operating platform, becomes identified with ladder use, employing developed task-specific accessories.

### DISCLOSURE OF INVENTION

The accessory mounting comprises an attachment device by which individual integrated accessories or an integrated accessorisable toolbar to which a diverse range of accessories can be detachably mounted, can be universally loaded variously on both faces of ladders. The said integration takes place through the said tools' incorporation with a horizontal member centrally located on the attachment device which has fittings to attach it, permanently or detachably, to the attachment device which has the means to accept the said fittings. The centre point of the horizontal member corresponds with the centre point of the attachment device.

In the case of an integrated accessorisable toolbar, the said horizontal member has arms attached to either end which project within the same plane, and have the means at their free ends to mount detachably accessories. The angle at which the said arms diverge or converge with respect to the horizontal member can be optimally set. In the interests of utility, the said arms can be adjustably hinged and extendible.

To provide a supportive or bracing effect, the said arms can be connected with a cross-member which can be supported by an attached strut/struts stemming from the device or it's environs. Beneficially, the cross-member and supporting strut/struts can be detachable, adjustably extendible and pivotally attached. The strut or struts can be replaced with a stay or stays, made from materials such as wire, chain or rope with appropriate fittings.

Beneficially, individual integrated ladder tool can be similarly configured.

The horizontal member can be attached, permanently or detachably, to the attachment device in a fixed orientation. In the interests of utility, the attachment fittings on the horizontal member and the attachment device can be differentiated to enable the horizontal member to rotate about it's horizontal axis and be locked in selected orientations, thereby providing adjustability to the angle at which integrated accessories or an integrated accessorisable tool bar project towards a surface within the vertical plane of a standing ladder when in place. Fittings to allow partial free rotation can be introduced.

Alternatively, each arm can be incorporated on the horizontal member to rotate separately about the axis of the horizontal member with fittings to secure each in selected positions.

To enhance the functioning of some accessories, such as a roof-ridge or a base-stabiliser, it is advantageous to use a shortened accessorisable toolbar. To this effect, an accessorisable toolbar can comprise interconnectable sections which can be variously arranged, providing options for varying the length and organisation of the said accessorisable toolbar.

The horizontal member can be attached pivotally to allow rotation in the vertical plane of a standing ladder with fittings which by engaging with fittings on the attachment device allow it to be fixed in selected positions, for storage and handling purposes for example.

Rung-gripping components can be variously incorporated within the structure of the attachment device. They can be variously constructed to accommodate varying rung spacings, employing such means as intersecting and/or sleeving elements and/or slotted mechanisms, for example, to provide variable extension. Incorporated rung-hooks project toward a ladder to hook on adjacent ladder rungs, accommodating varying rung breadths through means of their shaped diverging openings. The rung-gripping components can be discreet integrated units, or their functions can be assimilated within the structure of the attachment device.

The rung-hooks, which engage with adjacent rungs, can be beneficially shaped such that the sections engaged by ladder rungs and retaining the rung-hooks in position, run perpendicularly with the accommodating angle of the diverging opening. Thus rungs of different depths are accommodated by the angled openings of the rung-hooks diverging towards the attachment device, with the said retaining perpendicular sections providing the required purchase by being hooked behind adjacent ladder rungs. The rungs are gripped between the said perpendicular retaining section, and the face of the angled diverging opening of the rung-hook. Varying rung breadths are accommodated by the diverging structure of the rung-hook opening.

Shaped spacers can be introduced on the style-contacting faces of the rung-gripping components and/or the rung-hooks, for solid or hollow walled ladders, to provide clearance for the passage of clips securing secondary ladder stages. This, in conjunction with the above shaped rung-hooks, allows unobstructed movement when the apparatus, frontally-loaded, is elevated with secondary ladder stages and uniform contact with ladder styles, thus providing ready access to various heights.

The attachment device can be constructed to accommodate ladders with different style depths making it universally fitting, whilst providing clearance for the horizontal member.

This can include an increment to allow for clips which secure the sliding of secondary ladder stages for ladders with maximum style depth.

The attachment device with the incorporated rung-gripping components, or their assimilated functions, and horizontal member can be a fixed structure optimally sized to be universally fitting.

Beneficially, a centering mechanism, which can be lockable, can be centrally attached [with reference to the horizontal plane of a standing ladder] in such a way as it and any constituent parts, or modified constituent parts, can work without obstruction.

The centering mechanism can be, for example, a reciprocating device such as a turnbuckle or spring-loaded intersecting elements where opposite constituent parts, or modified constituent parts, extend and contract equi-distantly from the centre of the reciprocating device in response to the action of the centering mechanism to engage and disengage with either style of a ladder. The introduction of a centering mechanism provides a means by which the apparatus can be centered on a ladder, ensuring symmetry of placement of the attachment device and incorporated tool accessory or accessorisable toolbar, and exploiting the strength of support engendered by the proximity of the ladder styles to the contact areas on the rungs of the rung-gripping components. Beneficially, the said modified constituent parts can take the form of rung-gripping components. In this case, the structure of the attachment device can be variously constructed to guide and contain the extension and contraction of the attached rung-gripping components to and from the mid-point of the centering mechanism, in response to the action of the centering mechanism as they engage and disengage with styles of a ladder. In this case, the rung-gripping components can be variously modified to function within the structure of the so constructed attachment device, which can accommodate an optimal range of extension and contraction by the centering mechanism and it's constituent parts, or modified constituent parts, making the attachment device universally fitting, with respect to this arrangement.

The attachment device can be locked or clamped in position.

Implementing the above characteristics engenders a non-specific, universally attachable accessory mounting apparatus incorporating an accessory attachment system and a ladder attachment means to facilitate the accessorisation of ladders by providing a platform capable of various supported configurations, informed by mechanisms and characteristics that engender security and ease of attachment, ease and variety of placement, ease of assembly, handling and storage, to which an undetermined range of integrated ladder accessories, fit for purpose, can be readily attached within appropriate configurations with associated handling infrastructure to secure and facilitate ladder use and exploit the available and ready access-to-height that ladders provide. A tool box for storing components has fittings by which it can be converted into a trestle, for resting a ladder on for convenient loading, and a work surface for tools and materials when in situe.

### BRIEF DESCRIPTION OF DRAWINGS

A specific embodiment of the invention will now be described by way of example with reference to the accompanying drawing in which:

N.B.

All corresponding features in this and subsequent drawings are similarly annotated.

In the description, Ladder style depth is a reference to the distance between the outer edge of ladder styles, and the near upper edge of adjacent ladder rungs.

Ladder style width is the horizontal span between the two styles.

Rung breadth refers to the breadth of the rung, which runs parellel to ladder style depth.

Rung spacing refers to the gap between rungs.

Ladders can have broad or narrow styles with broad or narrow rungs.

The horizontal member is the mediating element by which an individual ladder tool accessory or an accessorisable toolbar is integrated with the attachment device.

Brief descriptions of the Drawings are in bold print.

FIG. 1a shows a frontal view of a fixed arrangement of the attachment device and tool/accessorisable toolbar placed secured on the front face of a ladder.

FIGS. 1a[i]-1c[i] illustrate an arrangement of the attachment device and tool/accessorisable toolbar which rotates about it's axis.

FIG. 1a[i] shows a frontal view of the attachment device and tool/accessorisable toolbar placed unsecured on the front face of a ladder.

FIG. 1b shows a frontal view of the attachment device and tool/accessorisable toolbar secured and in position on the front face of a ladder.

FIG. 1b[i] shows a frontal view of the attachment device and tool/accessorisable toolbar, with arms in a second wide-angled placement, secured and in position on the front face of a ladder.

FIG. 1c shows a rear view of the attachment device and tool/accessorisable toolbar secured and in position on the front face a ladder.

FIG. 1c[i] shows a frontal view of the attachment device and tool/accessorisable toolbar secured and in position on the rear face of a ladder.

FIG. 1d shows a side view of one of the rung-gripping components.

FIG. 1e shows a side view of one of the rung-gripping components with modified rung-hooks.

FIG. 1f shows an accessorisable toolbar, illustrating adjustably hinged, extendible arms with the means for attaching accessories.

FIG. 1f[i] shows an accessorisable toolbar, illustrating adjustably hinged, extendible arms with the means for attaching accessories in a second, wide-angled position.

FIG. 1f[ii] shows an alternative accessorisable toolbar.

FIG. 1f[iii] shows possible configurations of the said accessorisable toolbar.

FIG. 1g shows a frontal view of the device and accessorisable toolbar, frontally attached on a ladder, illustrating the supportive function of the horizontal assembly.

FIG. 1h shows a frontal view of the device, accessorised as a base stabliser, illustrating the bracing function of the horizontal assembly.

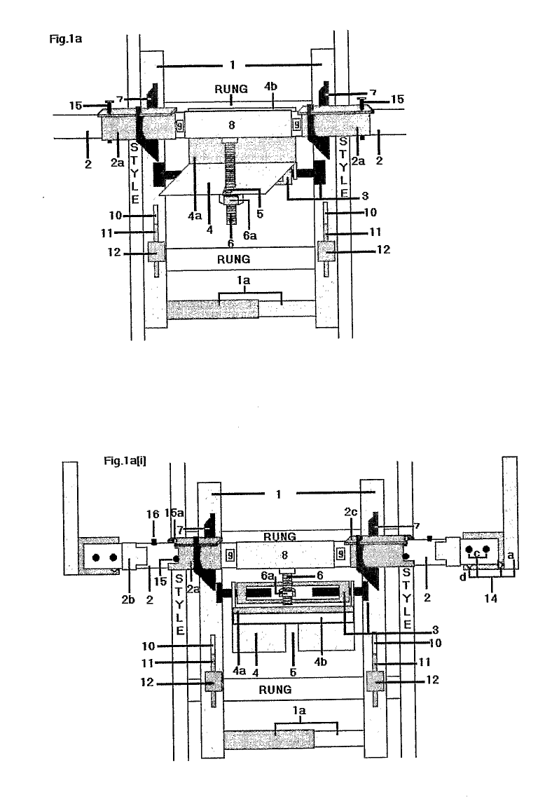

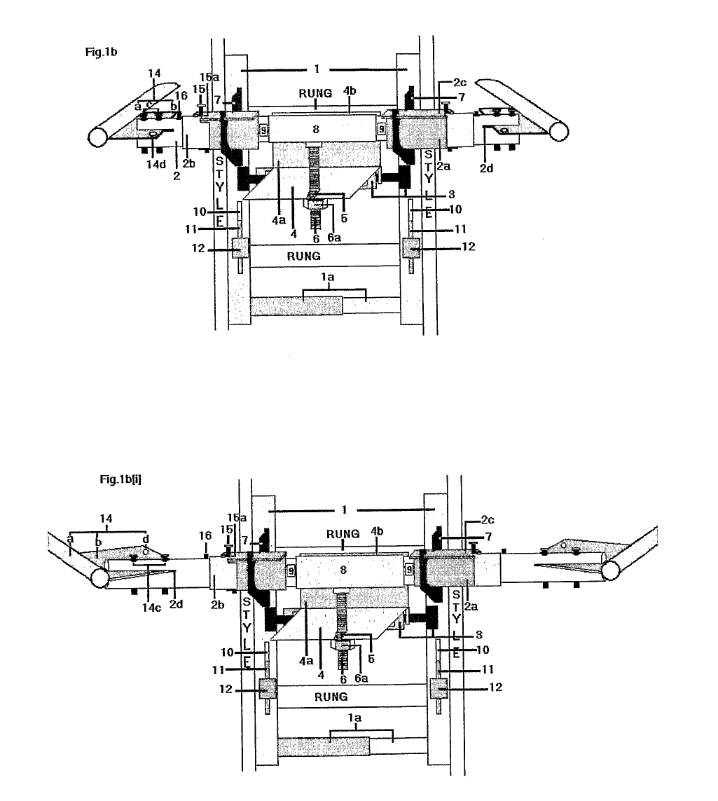

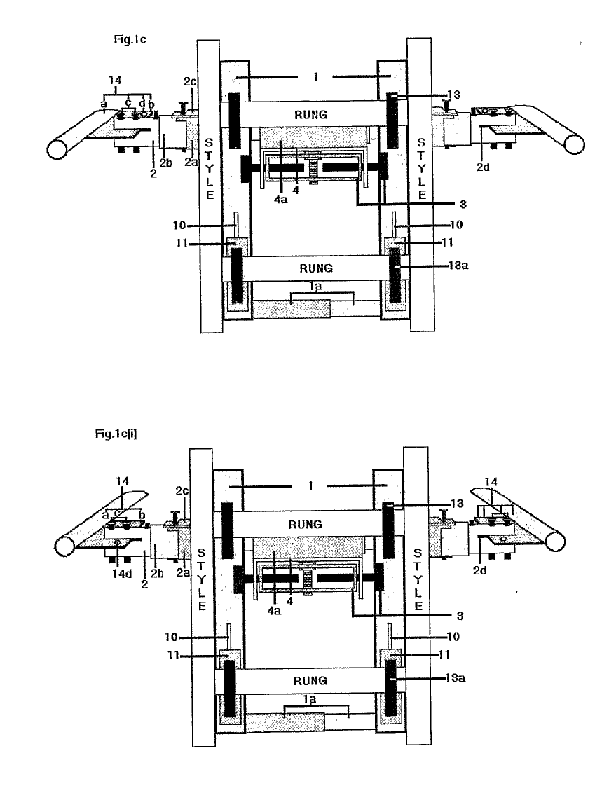

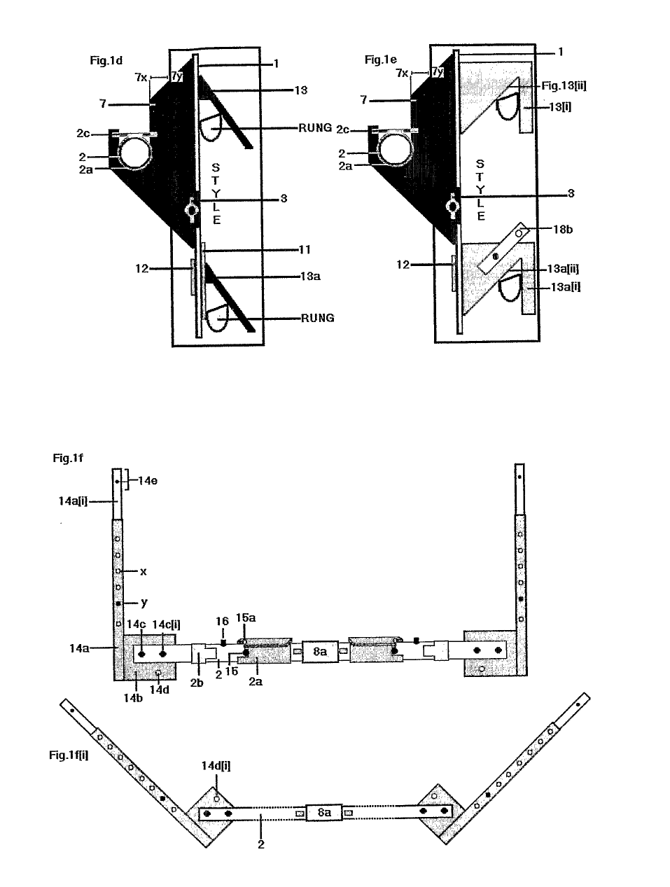

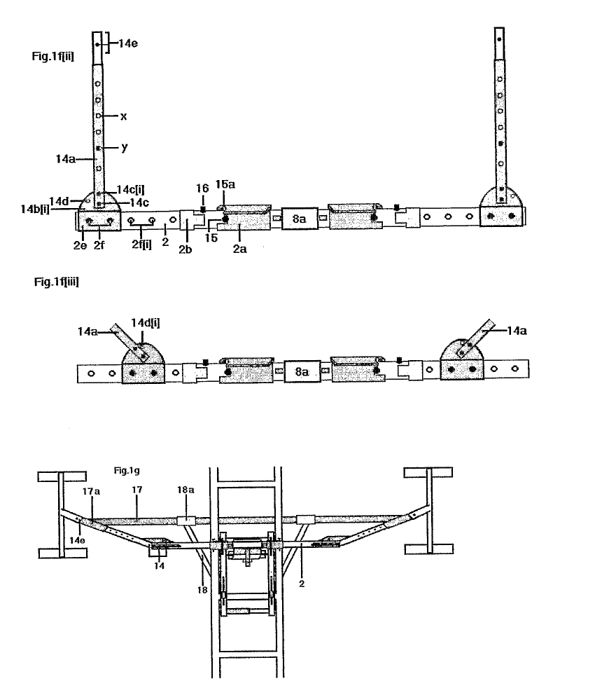

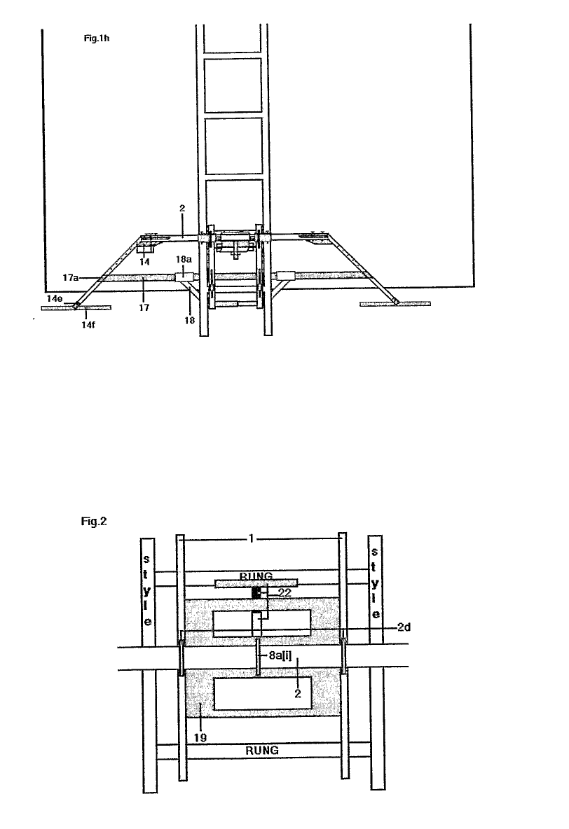

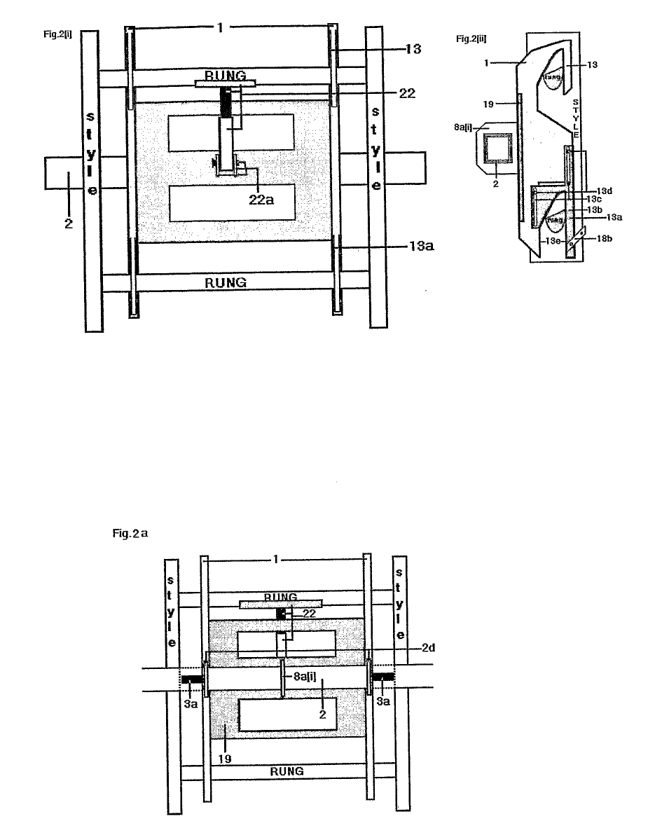

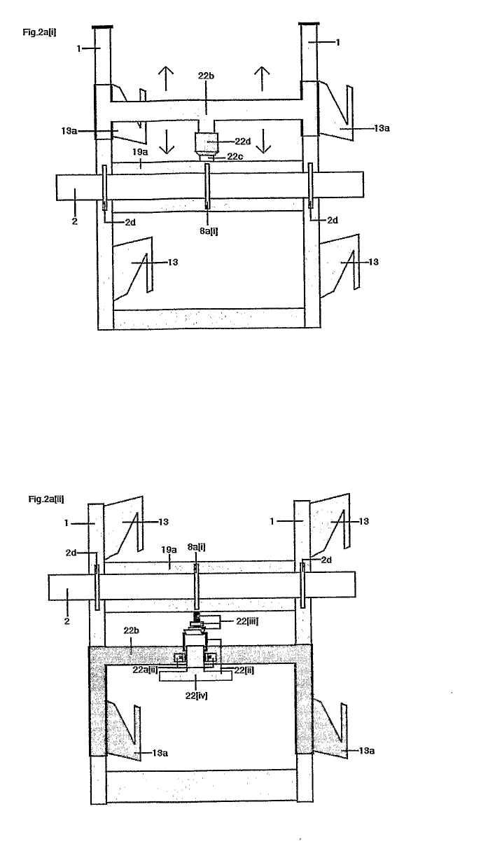

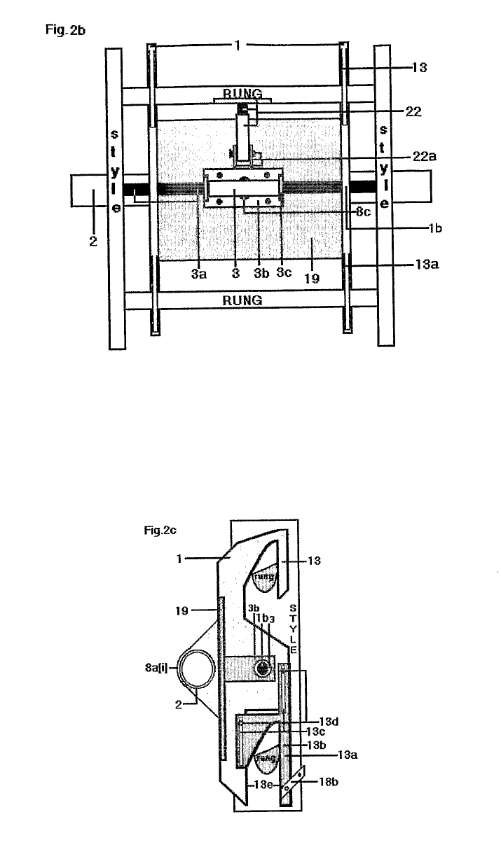

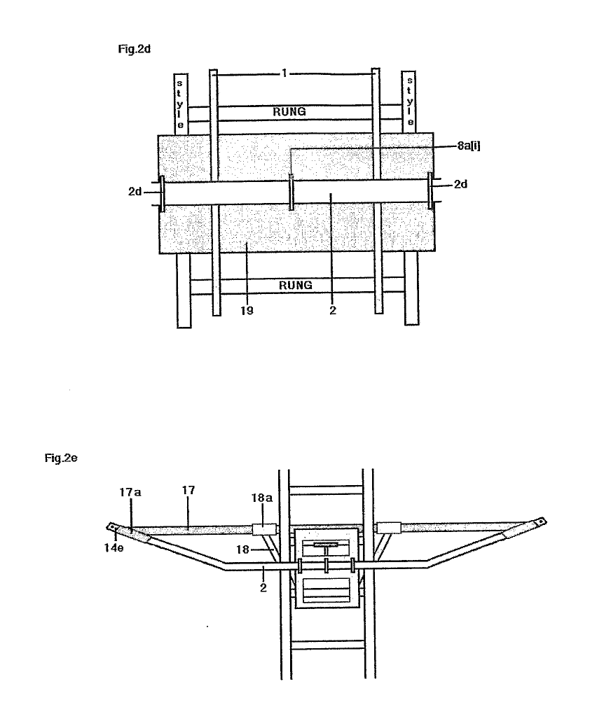

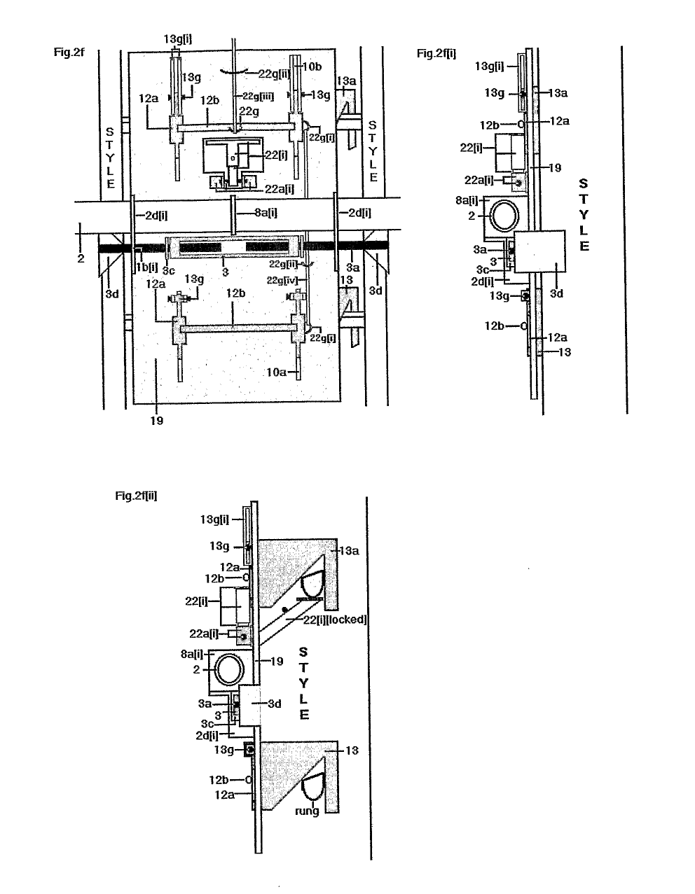

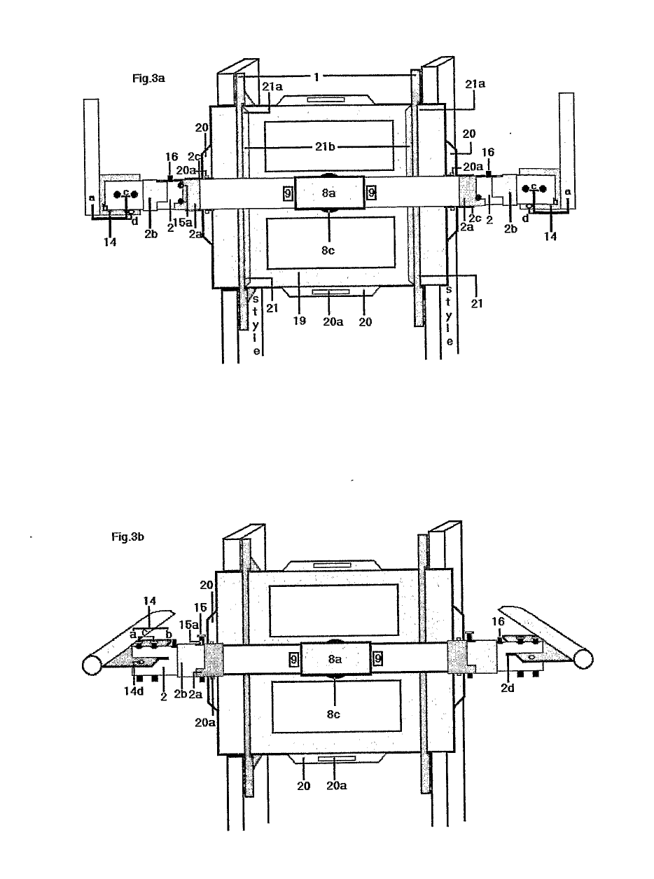

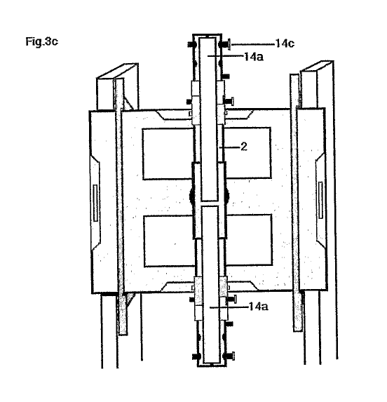

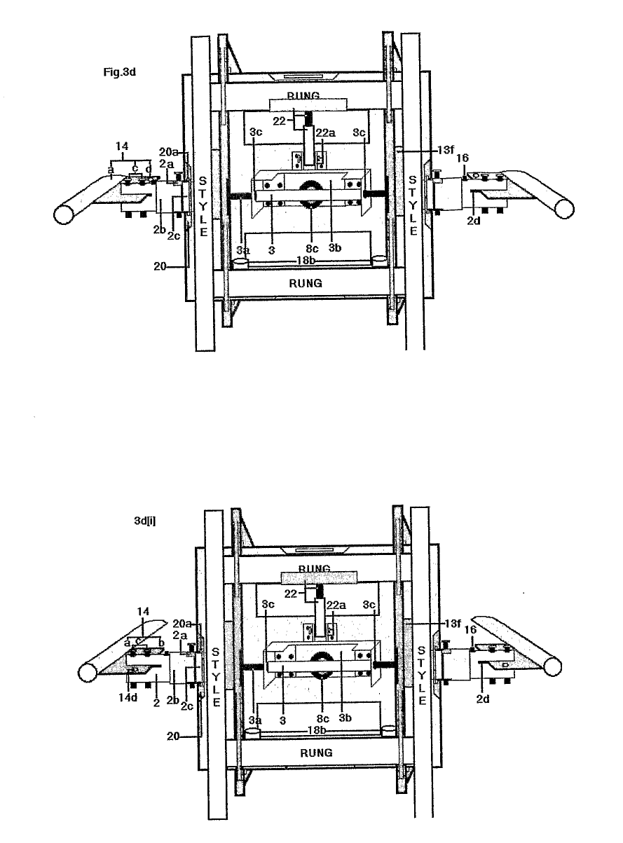

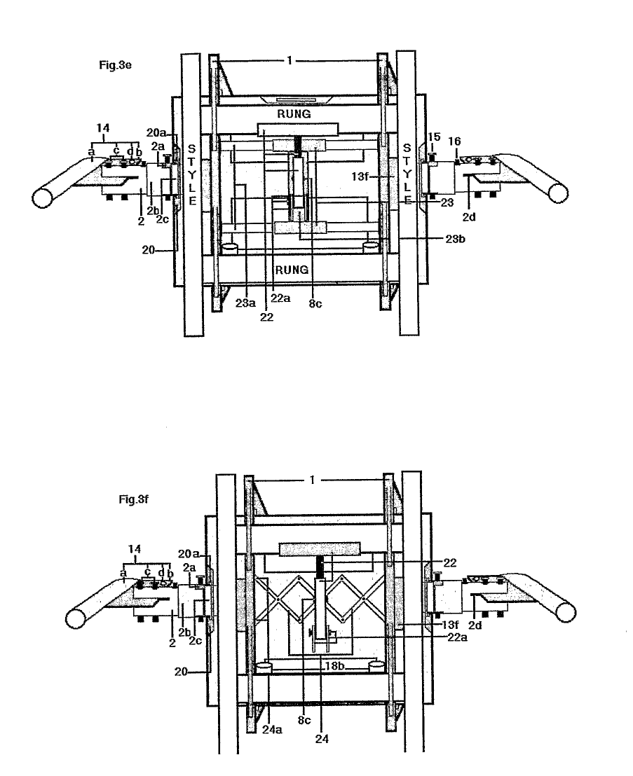

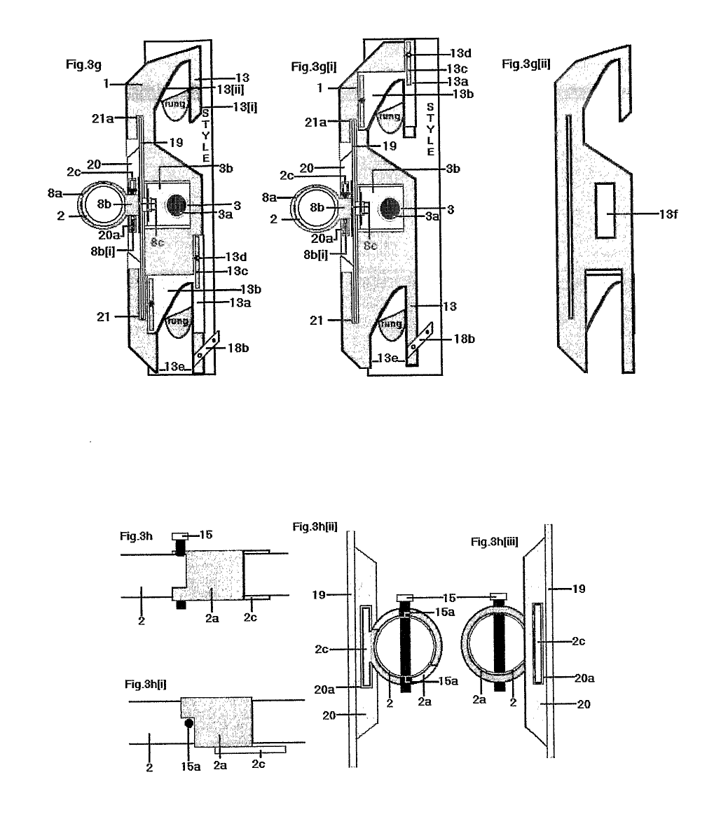

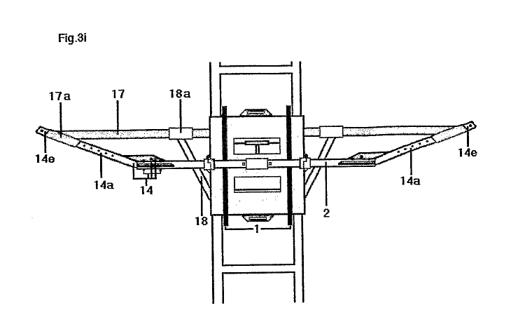

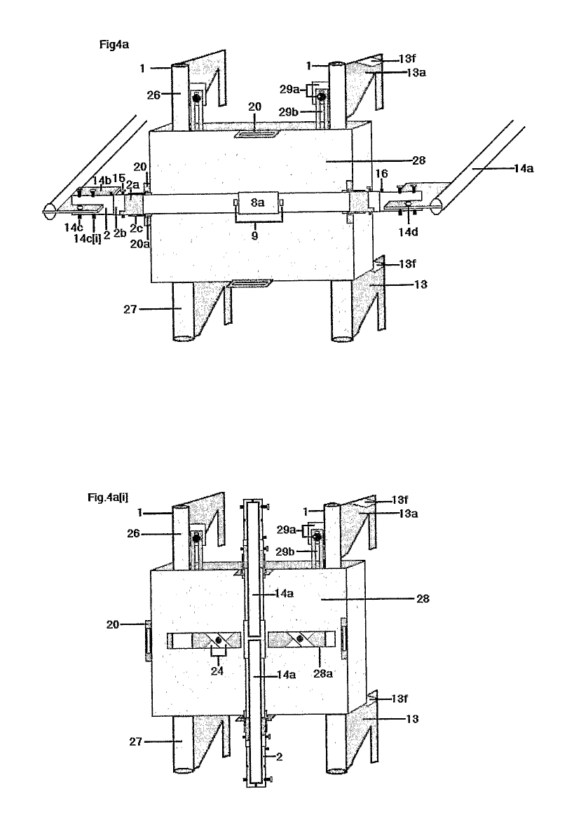

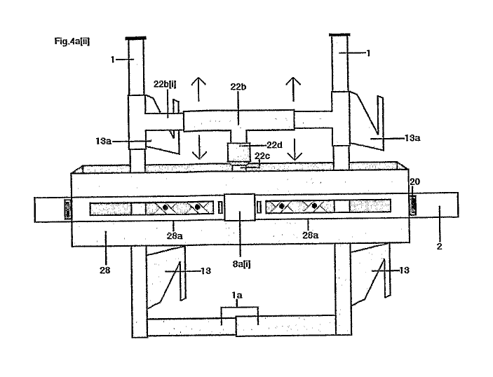

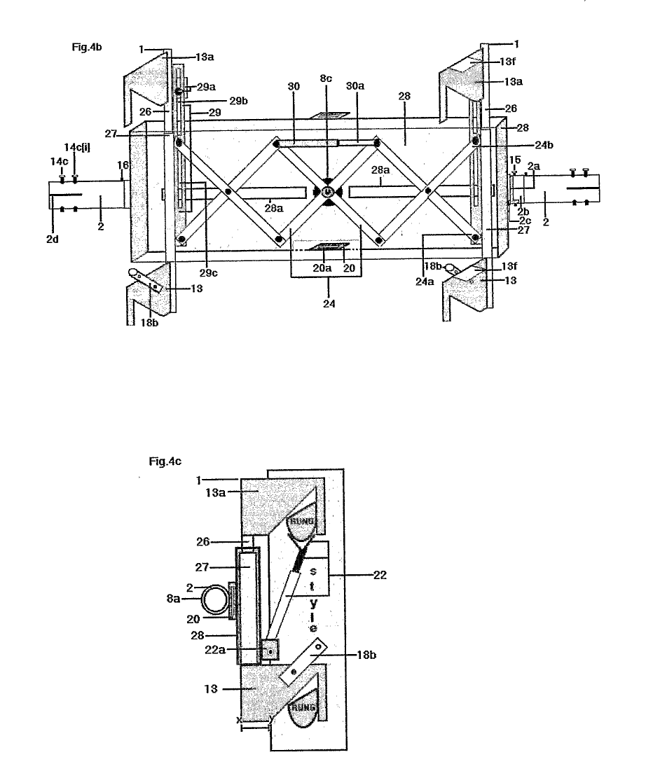

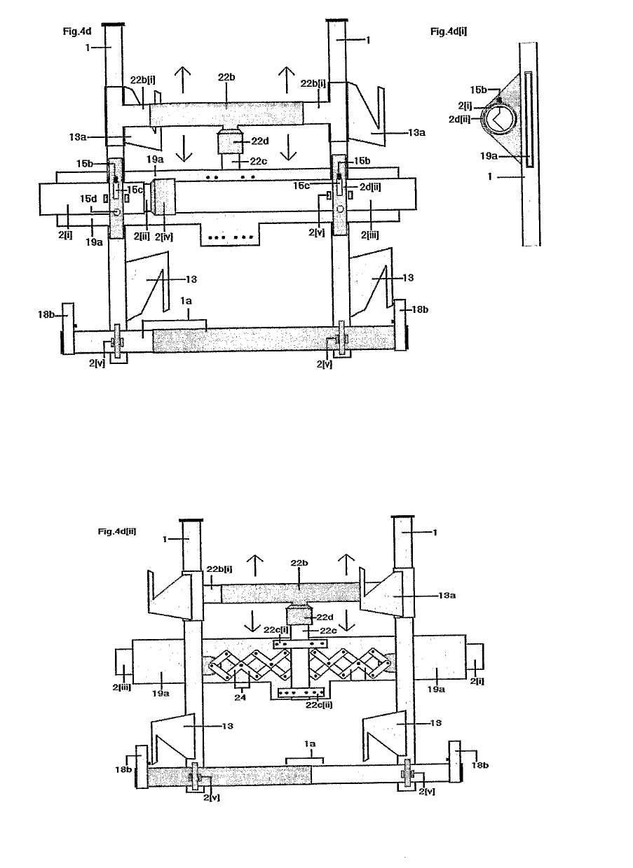

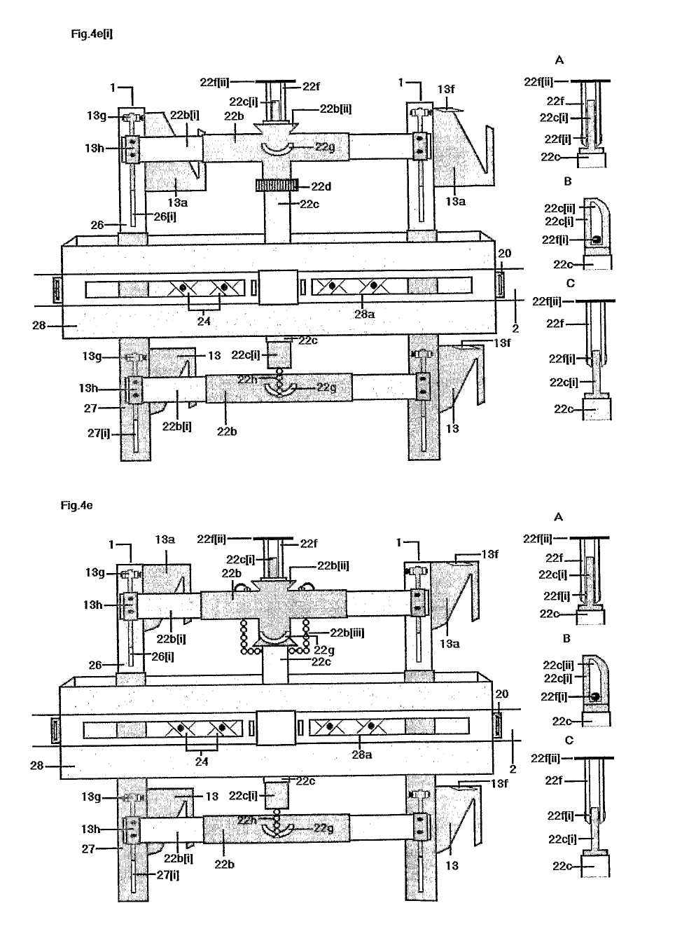

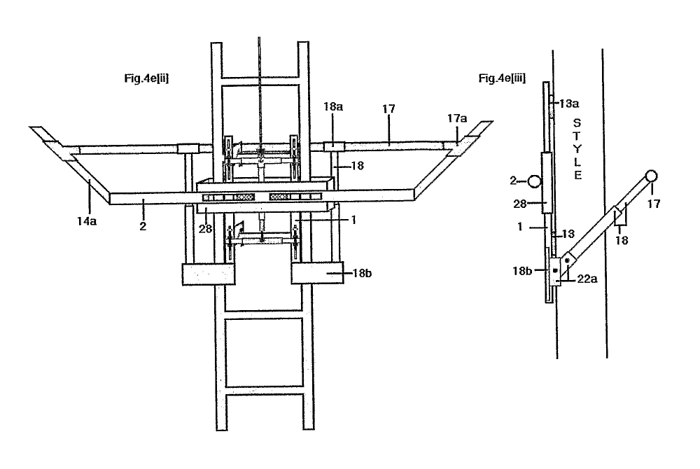

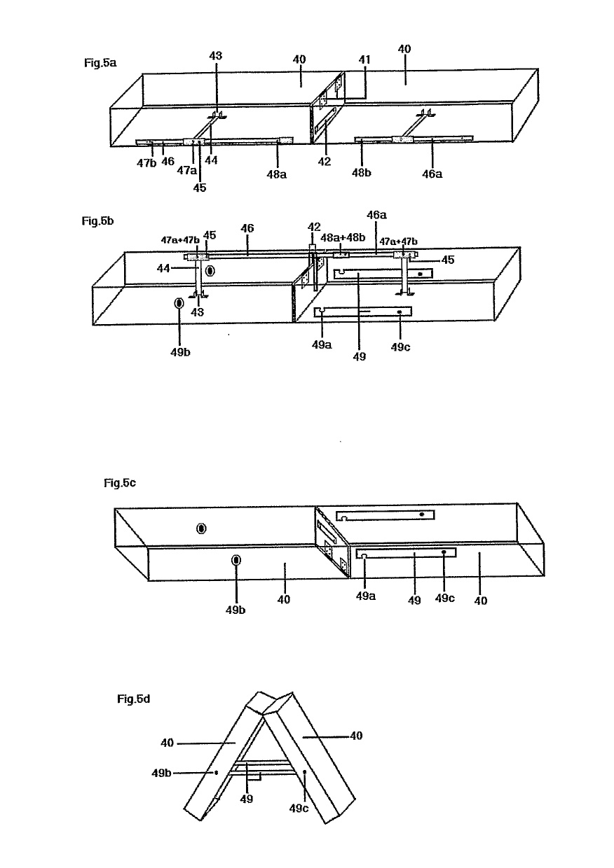

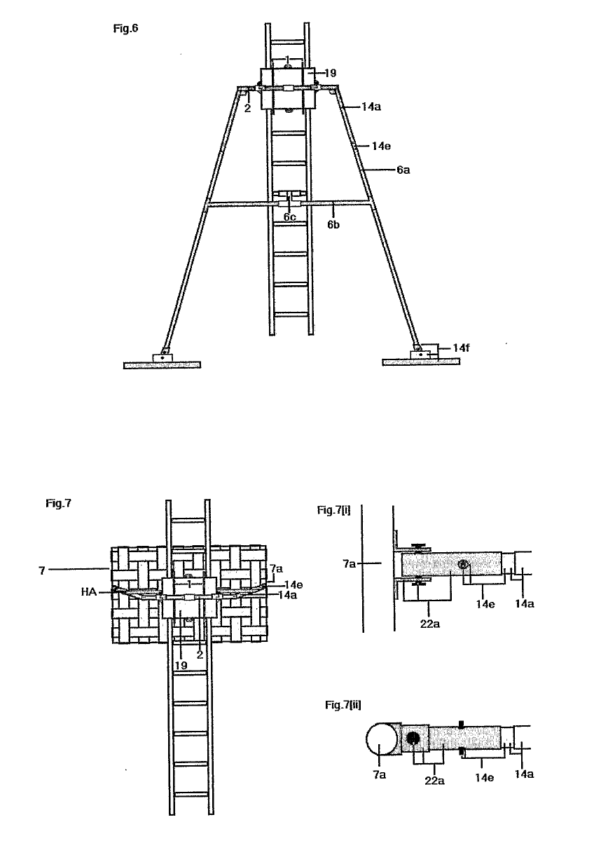

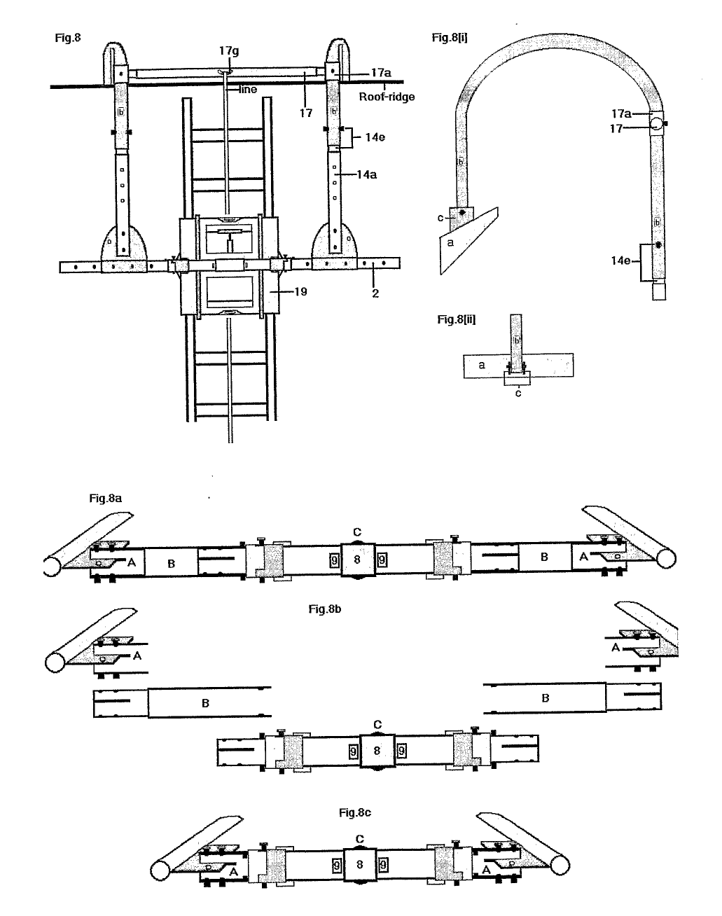

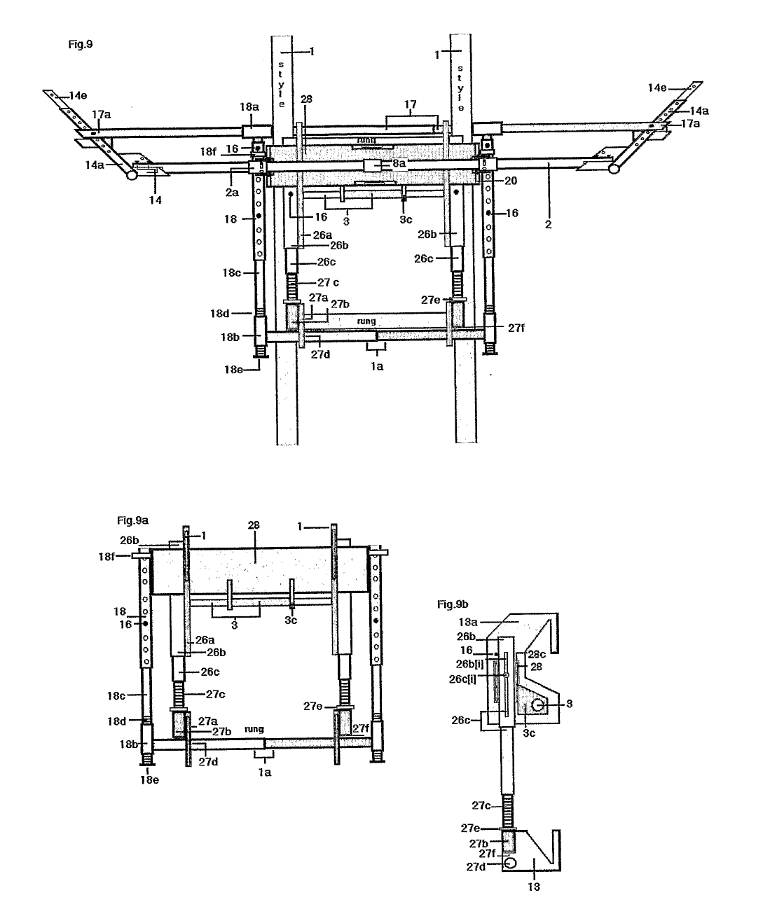

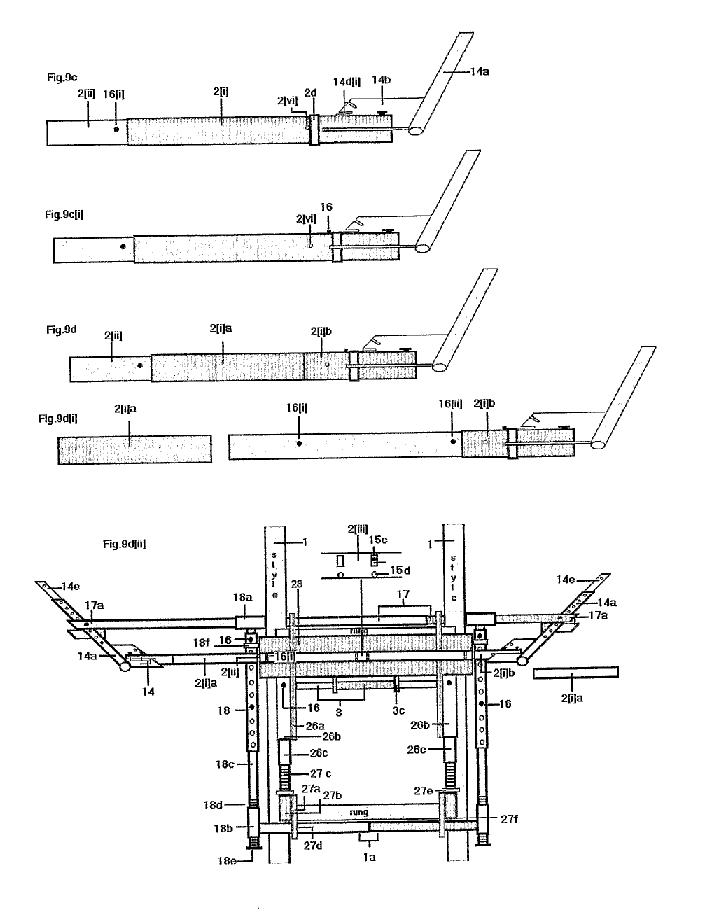

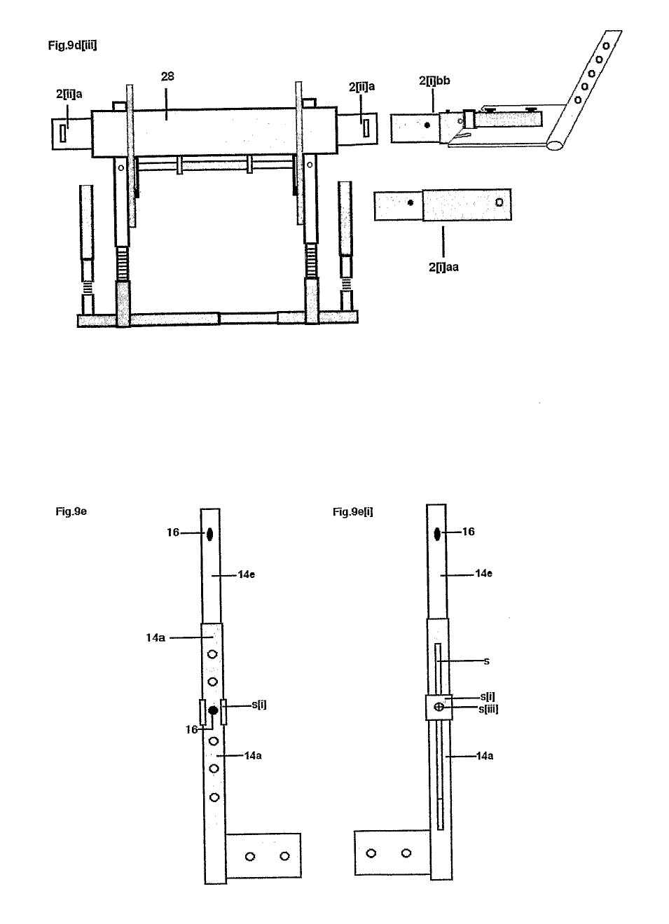

The device is placed on a ladder so that the diverging hooks on the rung-gripping components [P3,FIG. 1c,P4,FIGS. 1d,1,13,13a] engage the rungs. {It can be attached to either face of a ladder [P3,FIG. 1c,P3,FIG. 1c[i]]}. The lower hooks [13a] slide up and down slots [P3,FIGS. 1c,10] on slides [P1,FIG. 1a,P4,FIGS. 1d,11&12] to accommodate varying rung spacing; the diverging hooks [13,13a] accommodate varying rung breadths.

The rung-hooks [P4,FIG. 1d] can be shaped [P4,FIG. 1e] so that the rung-breadth accommodating angle of the hook [P4,FIGS. 1e,13[ii],13a[ii]] is travelling into the frame [P4,FIG. 1e] rather than away from it [P4,FIGS. 1d,13,13a]. This ensures that the section of rung-hooks engaged by the rung [P4,FIGS. 1e,13[i],13a[i]], runs approximately perpendicular to the diverging contour of a rung-hook. Because it's function is to provide support, it's dimensions can remain constant therefore be optimally shaped, and gauged for strength.

Rung-hooks thus constructed prevent their entanglement with primary stage ladder rungs when the attachment device in position ascends with secondary ladder stages. Incorporating extendible intersecting tubing [FIGS. 1a,1a] maintains a rigidity to the structure for easy handling, while accommodating ladders with different style widths.

The rung-hooks can be phlanged or thickened to maximise surface contact with the rungs.

If the gap at the widest point of divergence of the rung-hook opening is 7.5 cm or more within the context of practicality, the attachment device can be attached to a range of step-ladders

In this embodiment [FIGS. 1a-1h] an L-shaped, centrally slotted plate [P1,FIGS. 1a[i],4,4a,5] is hinged centrally on the turnbuckle [P1,FIGS. 1a[i],3] to which are attached rung-gripping components [P1,FIGS. 1a[i],1]. When the bolt [P1,FIGS. 1a[i],6], incorporated centrally on the swivelling sleeve, retained centrally on the tool/accessorisable toolbar [P1,FIGS. 1a[i],2,8] by blocks [P1,FIGS. 1a[i],9] engages with the slot [P1,FIG. 1a,P2,FIGS. 1b,5], the toolbar is centred with respect to the attachment device. When the turnbuckle, calibrated to be centrally positioned, is turned and the rung-gripping components expand to engage with the styles [P1,FIGS. 1a,1], the attachment device is centred on the ladder, as is the tool/toolbar, producing a symmetrical configuration, optimising a balanced load distribution. The load is applied where the rung-hooks engage the ladder rungs near the ladder styles [P3,FIGS. 1c,1,13,13a], ensuring strength of support. Spacers can be placed on the style-contacting faces of the rung-gripping components, to accommmodate clips securing secondary ladder stages, allowing the passage of the device when frontally mounted and ascending or descending on secondary ladder stages. This is a significant benefit of a front-loading device, providing variable access to height.

For ladders with hollow-walled styles, the spacers have to be wider, and can take the form of add-ons.

In both cases, the spacers have to be optimally sized with reference to style depth, measured from the outer edge of the ladder style to the near edge of adjacent rungs to prevent interference with the said clips when the apparatus is elevated on secondary ladder stages. On some ladders, the clips bend around the edge of the styles.

In this embodiment, the broken, slotted hoops of the rung-gripping components [P1,FIGS. 1a,7,P4,FIGS. 1d,7] in conjunction with the concentric, locking sleeves [P1,FIGS. 1a,2a] on the toolbar [2], secured by a pin & hole mechanism [P1,FIGS. 1a,15,], allow the device to be ‘broken’ into two parts. When the pin [P1,FIGS. 1a,15] is removed, the locking sleeves [2a] can be pulled back, enabling the tool/accessorisable toolbar to be removed from the slotted broken hoops [7]. This allows easy placement and removal of the tool/accessorisable toolbar, or tool/accessorisable toolbar and attachment device, for easier handling, transport and storage.

To fit the tool/accessorisable toolbar [2] on to the attachment device, the locking sleeves [P1,FIGS. 1a,2a], which fit closely on the tool/accessorisable toolbar, can be withdrawn allowing the tool bar [2] to be introduced into the broken slotted hoops [P1,FIG. 1a,P4,FIGS. 1d,7]. The locking sleeves are moved into the broken slotted hoops [7] into which they fit snugly, stopped by blocks [P1,FIGS. 1a,9]. Incorporated plating on the locking sleeves [P1,FIG. 1a,P4,FIG. 1d,P15,FIGS. 3h-3 [iii],2a,2c] engage with the slots of the broken hoops. The locking sleeves are optimally sized as to accommodate ladders of different ladder style widths. Holes in the tool/accessorisable toolbar and the locking sleeves are aligned, and secured in place by the introduction of a pin [P1,FIGS. 1a[i],15,15a,P1,FIGS. 1a,15] locking the tool/accessorisable toolbar on to the attachment device. Securing the device at these locations maintains the linear coherency of the tool/accessorisable toolbar, and diffuses loading across the attachment device, and because of the action of it's centering mechanism, across the styles of the ladder at that location.

The angle at which the tool/accessorisable toolbar projects, upwards or downwards towards a vertical surface on a standing ladder, can be varied by providing additional holes in the tool/accessorisable toolbar to line up with the holes in the locking sleeves. A preferred position can be secured by introducing the pins. This can be accomplished by other means.

The device and toolbar are secured by tightening the nut [P1,FIG. 1a,P2,FIGS. 1b,6a], against the hinged L-shaped plate [4,4a], on the bolt [6] which levers a ‘lipped’ section of the L-shaped plate [P1,FIG. 1a,P1,FIGS. 1a[i],4a,4b], against a ladder rung [P1,FIG. 1a,P3,FIGS. 1c,4a,4b], locking the device in place, and maintaining it's centrality, and also that of the tool/accessorisable toolbar.

The combination of the swivelling sleeve [8], the length of the incorporated bolt [6], the slot [5], and the hinging L-shaped plate [4,4a], mean that differing rung breadths and depths can be accommodated by this arrangement.

Developing the swivelling sleeve feature [P1,FIGS. 1a,8] and the pin and hole system [P1,FIGS. 1a[i],15,15a], the tool/accessorisable toolbar can be provided with a limited free, rotational capacity. By excising identical sections from each locking sleeve [P1,FIGS. 1a[i],2a,], with pins in place, the tool/accessorisable toolbar has limited free rotation, further rotation being prevented by the remaining unexcised sections of the locking sleeves engaging the pins. The degree of free rotation is determined by the size of the excised sections.

Thus the tool/accessorisable toolbar can freely rotate from the position shown in P1,FIG. 1a[i] to that shown in P2,FIG. 1b, being stopped where the pins engage with the remaining unexcised sections of the locking sleeves. The position around which this limited free rotation occurs can be varied by aligning, alternative additional holes in the tool/accessorisable toolbar with those in each locking sleeve, secured with pins [15].

To lock the tool/accessorisable toolbar in the new position, secondary sleeves [P1,FIGS. 1a[i],2b], shaped to intersect with the excised sections of the locking sleeves, are moved to engage with the locking sleeves [P2,FIG. 1b], preventing rotation. The secondary sleeves are kept in place by spring-loaded buttons [P1,FIG. 1a[i],P2,FIG. 1b]. By withdrawing the pins [15] in this position, the tool/accessorisable toolbar can rotate completely, while remaining in place.

These characteristics can be achieved by other means.

The partial rotation of the tool/accessorisable toolbar enables the apparatus to be fitted on a ladder in situe, with the tool/accessorisable toolbar arms resting on the vertical surface [P2,FIG. 1b]. With the device secured, the top of the ladder can be lifted of the surface by the operator on the ground. The arms [14] will drop down into position, determined by the stopping action of the remaining sections of the excised locking sleeves [P2,FIG. 1b] and the pin and hole system [P2,FIGS. 1b,15,15a]. The lower part of the ladder is pulled out, and the ladder, the device and tool/accessorisable toolbar are then in place. The secondary sleeves [2b] can then be moved into position, and the tool/accessorisable toolbar is locked in position.

This arrangement is configured so that when the arms drop down and the bottom of the ladder is pulled out, the ladder and device are set at an angle of 75 degrees to the wall, the arms projecting at approximately right-angles to the wall. The position around which this limited free rotation occurs can be varied by aligning, alternative additional holes in the tool/accessorisable toolbar with those in each locking sleeve, secured with pins [15].

After use, the sliding sleeves [2b] are disengaged, the ladder is raised, the arms rest on the surface at this raised height so that when the ladder is dropped down, the arms, now free to rotate, stay at this point, allowing the top of the ladder to rest on the surface. The operator can then carm the ladder and detach and remove the tool/accessorisable toolbar, or the tool/accessorisable toolbar and the attachment device.

The slotted, broken hoops [7] on the rung-gripping components [1] project out from the attachment device [P4,FIG. 1d,FIGS. 1e,7x-7y] to accommodate ladders of different depths of styles when the tool/accessorisable toolbar and locking sleeves are in place.

The gap between the tool/accessorisable toolbar and locking sleeves, once in place, and ladder style, created by the projecting slotted broken hoops [P4,FIG. 1d,FIGS. 1e,7x-7y] can accommodate ladders of different style depths with respect to the position of the rungs and their breadths. This gap [P4,FIG. 1d,FIGS. 1e,7x-7y] can additionally accommodate clips securing the passage of secondary ladder stages when the attachment device and tool/accessorisable toolbar are mounted on secondary ladder stages.

This accommodation prevents the toolbar/attachment device, when mounted and ascending and descending on secondary ladder stages, from interfering with the clips securing the sliding of secondary ladder stages.

The gap between the toolbar and locking sleeves, once in place, and a ladder style, created by the projection of the slotted broken hoops [P4,FIG. 1d,P4,FIGS. 1e,7x-7y] is optimally sized so as to make the attachment device universally fitting.

The above features ensure that the device with toolbar will ascend and descend freely with secondary ladder stages when attached to them, enabling the device and toolbar to be used easily at various heights.

Permutations of the described features above can be applied to a combination of individual, integrated stand-alone tools or accessorisable toolbar and attachment device, and even a specific ladder, where market demand determines limited production costs, reflected in the presence or absence of certain features.

Further diversification, depicted in the above, and subsequent, embodiments are the addition of adjustably hinged, extendible arms [P4,FIG. 1f,P4,FIGS. 1f[i],14a,14a[i]], with the means to attach accessories [P4,FIG. 1f,FIGS. 1f[i],14e]—an accessorisable toolbar. In the present embodiments, the arms [P4,FIG. 1f,P4,FIGS. 1f[i]14a] are hinged to the horizontal member [2]. Plating, attached to the arms [P4,FIGS. 1f,14a,14b] fit into slots at either end of the horizontal member [P3,FIGS. 1c,2d]. Holes in the plating [P4,FIG. 1f,P4,FIGS. 1f[i],14d,14d[i]] are aligned with corresponding holes in the horizontal member [P4,FIGS. 1f,14c,14c[i], and secured by the introduction of pins, where 14c is the pin and hole securing the hinging position, and pin 14c[i], the positional pin, which in conjunction with holes 14d and 14d[i] provide alternative positions for the hinging arms.

Other positions can be made available by providing other holes for the positional pin [14c[i]] in the plating [P4,FIGS. 1f,14b,14d,P4,FIGS. 1f[i],14d[i]]

Other means can be used to accomplish variable hinging.

P2,FIG. 1b[i] shows the attachment device with an accessorisable toolbar in a wide-angle position.

FIGS. 1f[ii] and 1f[iii] show a variation of the accessorisable toolbar, where the arms are hingedly attached to plating incorporated on sleeved sections which can be variously positioned along the horizontal section of the toolbar [P5,FIGS. 1f[ii],14a,14b[i],14c,14c[i],14d,14[i],2e,2,P5,FIG. 1f[iii]].

FIG. 1f[iii] shows the arms in a second, angled positioned using a similar hinging and positional pin and hole system as in FIGS. 1f and 1f[i]. The position of the arms has been moved towards the center of the toolbar by sliding the sleeved sections with the incorporated plating on which the arms are hinged. The sleeved sections are secured using a pin and hole system with additional holes for alternative positions [P5,FIGS. 1f[ii],2,2e,2f,2f[i]].

In a further variation, the toolbar can be simply attached and adjacent off-set pairs of holes, in this case, can be introduced in the circumference of the toolbar, here tubular, by which the sleeved sections can be secured allowing the arms to project at selected angles within the vertical field of a standing ladder and at different positions along the length of the toolbar.

The arms can be adjustably extendible using sleeved members {P4,FIGS. 1f,14a,14a[i]], with calibrated holes [14a,x] in both sleeving sections [14a], and spring-loaded buttons [14a[i],y] in the sleeved sections [14a[i]]. Variously-holed sleeved accessories can be attached to the ends of the arms where spring-loaded button secure them [P4,FIGS. 1f,14e].

The arms can be connected using an extendible cross-member, supported, or braced, by a strut or struts stemming from the device or it's environs [P5,FIGS. 1g,17,17a,18,18a,]; the struts [18] can be extendible and hingedly attached to the cross-member [18a], and connected to the attachment using a hinged fitting [P4,FIGS. 1e,18b]. This allows for different configurations. P5,FIG. 1g illustrates a supportive function, in the case of a stand-off stabiliser. Using the above the apparatus [P5,FIGS. 1g,17,17a,18,18a]—the horizontal assembly—in this function also reinforces a braking effect should the base of the ladder move outwards from the vertical surface; the arms and attached accessory, braced by the horizontal assembly in this movement, acting as a braking mechanism to further movement.

P6,FIG. 1h illustrates the bracing effect of the horizontal assembly where the apparatus is accessorised as a ladder base-stabiliser [14f].

In other situations, the bracing and/or supportive function performed by the said strut/struts can be conveniently carried out by a stay or stays attached to, or in the location of, the attachment device and the said cross-member.

FIGS. 2-2e illustrate a utilitarian embodiment offering characteristics of front- or rear-attachment, universality of attachment, and with the addition of a centering device, symmetry of placement, conforming to a possible market demand which limits production costs.

FIGS. 2-2[ii] illustrates a utilitarian variation of the accessorisation equipment employing a fixed frame with fixedly attached rung-gripping components, and a fixed tool/accessorisable toolbar which in this case is rectangular.

FIGS. 2a-2e illustrate the above utilitarian variation incorporating a centering mechanism.

FIG. 2a shows a frontal view of the attachment device and the tool/accessorisable toolbar frontally loaded on a ladder.

FIG. 2a[i] shows a frontal view of an open-structured variation frontally loaded on a ladder, where the upper rung-hooks are inverted and slide to engage with the underside of the adjacent rung and are locked in position.

FIG. 2a[ii] shows a frontal view of an open-structured variation with an alternative snap-on locking mechanism.

FIG. 2b shows a rear view of the attachment device and tool/accessorisable toolbar frontally loaded on a ladder, illustrating a locking mechanism.

FIG. 2c shows a side view of a modified rung-hook system.

FIG. 2d shows a frontal view of the attachment device with a horizontally extended frame, frontally loaded on a ladder.

FIG. 2e shows a frontal view of the attachment device and tool/accessorisable toolbar frontally loaded on a ladder.

FIGS. 2f-2f[ii] shows a frontal and profile views of a variation with retractable rung-hooks and tool/accessorisable toolbar frontally loaded on a ladder.

In a utilitarian embodiment [P6,FIG. 2,P7,2[i]2[ii]] a frame [19], which can be constituted from various materials, is attached to a ladder by means of the rung-gripping components [P6,FIGS. 2,1,P7,FIGS. 2[ii],1], and locked in position by an adjustable, quick-release, mechanism [P7,FIGS. 2[i],22,22a]. The frame is metal plating, in this case, and can have sections removed for access and weight reduction. It can also be an open structure [P8,FIG. 2a[i]].

The rung-hooks on the rung-gripping components [P7,FIGS. 2[ii],1,13,13a] are modified and have been shaped out of two sections of metal plating [P7,FIG. 2[ii]]. These can be moulded. The sections, facing each other and at right-angles to the frame [19] projecting towards the ladder [P7,FIGS. 2[ii],19,1,13,13a], can be folded extensions of the frame with the rung-accommodating sections removed. The rung-hook openings that accommodate varying rung-breadths beneficially diverge towards the frame of the attachment device [P7,FIGS. 2[ii],13,13a,13b].

If the gap at the widest point of divergence of the rung-hook opening is 7.5 cm or more within the context of practicality, the attachment device can be attached to a range of step-ladders.

To accommodate different rung spacing, in this embodiment, a slotted rung-hook shape [P7,FIGS. 2[ii],13b] cut or moulded out of metal, in this case, slides up and down an optimal gap [P7,FIGS. 2[ii],13e] using the slots and guides [P7,FIGS. 2[ii],13c,13d], the diverging opening of the sliding rung-hook [13b] accommodating different rung breadths.

Alternatively, this arrangement can be introduced at the upper rung-hook

A fitting [P7,FIGS. 2[ii],18b] can be introduced to engage with a strut, or struts [P10,FIGS. 2e,18] to brace or support a cross-member [P10,FIGS. 2e,17] connecting the arms of the tool/accessorisable toolbar as described in the previous embodiment.

The horizontal member can be fixedly attached to the attachment device using various fittings [P6,FIGS. 2,2,2d,8a[i],P7,FIGS. 2[ii],2,8a[i]] where the horizontal member is rectangular for practicality. It can also be welded to the attachment device where appropriate.

The dimensions of the rung-hooks, in terms of the distance they project from the attachment device to engage with the ladder rungs, the attachment device, and the fittings that secure the horizontal member, can be optimally gauged to universally accommodate ladders with varying style depths, whilst providing clearance for the horizontal member. This clearance can include an increment to allow for clips which secure the sliding of secondary ladder stages for ladders with maximum style depth.

In the embodiment, FIGS. 2a-2e, a centering mechanism [P9,FIGS. 2b,3a,3b], a turnbuckle in this case, is attached centrally to a rigid frame [P7,FIG. 2a,P9,FIGS. 2b,19] to which rung-gripping components [P7,FIG. 2a,P9,FIGS. 2b,1] are fixedly incorporated. The centering mechanism, a turnbuckle in this case, is retained in a centrally {with reference to the horizontal} attached bracket [P9,FIGS. 2b,3b,3c,] which allows the unobstructed turning of the handle and the associated movement of the threaded sections [P9,FIGS. 2b,3a]. The ends of the threaded sections can be the style-contacting elements themselves, or they can be specifically adapted. The threaded sections of the turnbuckle project through adjacent holes in the rung-gripping components [P9,FIGS. 2b,1,3a,1b] and allow their unobstructed movement.

The horizontal distance between each pair of rung-hooks can be optimally narrow to accommodate ladders with narrow style-widths; the centering device, the turnbuckle in this case, and it's constituent style-contacting elements, can extend to accommodate ladders with increasing style-widths.

The frame is metal plating, in this case, and can have sections removed [P10,FIG. 2e] for access and weight reduction. It can also be an open structure [P8,FIG. 2a[i]].

The rung-gripping components [P9,FIGS. 2c,1,13,13a] have been modified and are two sections of metal plating [P9,FIG. 2c], in this case, with rung-hook shaped sections removed from the upper regions, and optimal gaps provided in the lower regions. These can be moulded. The sections, facing each other and at right-angles to the frame [19], can be folded extensions of the frame with the rung-accommodating sections removed.

The distance between the upper rung-hook and the gap in the lower section is optimal in order to accommodate ladders with varying rung-spacing.

To accommodate different rung spacing, with the upper rung-hooks in position, a shaped slotted rung-hook [P9,FIGS. 2c,13b], slides up and down the said lower gap [P9,FIGS. 2c,13e] using the slots and guides [P9,FIGS. 2c,13c,13d], the angle of the sliding rung-hook [13b] accommodating different rung-breadths.

The rung-hook openings that accommodate varying rung-breadths beneficially diverge towards the frame of the attachment device [P9,FIGS. 2c,1,13,13a,13b].

If the gap at the widest point of divergence of the rung-hook opening is 7.5 cm or more within the context of practicality, the attachment device can be attached to a range of step-ladders.

This arrangement can be introduced at the upper rung-hook. [See P16,FIG. 3g[i]].

A fitting [P9,FIGS. 2c,18b] can be introduced to engage with a strut, or struts [P10,FIGS. 2e,18] to brace or support a cross-member [P10,FIGS. 2e,17] connecting the arms of the tool/accessorisable toolbar as described in the previous embodiment.

The dimensions of the rung-hooks, in terms of the distance they project from the attachment device to engage with the ladder rungs, the attachment device, and the fittings that secure the horizontal member, can be optimally gauged to universally accommodate ladders with varying style depths, whilst providing clearance for the horizontal member. This clearance can include an increment to allow for clips which secure the sliding of secondary ladder stages for ladders with maximum style depth.

Materials such as aluminium, hard plastics and fibreglass can be employed to fabricate various elements.

Constituent style-contacting elements of the centering device move independantly of the frame [19] and rung-gripping components [P9,FIGS. 2b,19,1] to engage or disengage with ladder styles in response to the action of the centrally attached centering device, ensuring symmetry of placement.

As before, the horizontal member [P7,FIGS. 2a,2] is centrally attached, either permanently or detachably, in this case, at points P7,FIGS. 2,2d,8a[i] to the fixed frame. Attaching the horizontal member using the said three locations, distributes the load across the attachment device, and maintains the rigidity of the horizontal member.

The plate [19] diffuses the load over it's area preventing concentration of load.

The above effect can be enhanced by extending the area of the plate horizontally [P10,FIG. 2d].

The attachment device can be secured using an adjustable quick-release locking mechanism [P9,FIGS. 2b,22,22a]

Other locking systems can be employed such as the one illustrated in P8,FIG. 2a[i] showing opposing sleeved rung-hooks [13a] joined by a cross-member [22b] sleeving and locking [22d] on to a section [22c] connected to the cross-sectional plating [19a]. Here, the opposing sliding hooks engage with the under-section of the rung, the angled rung-hooks accommodating the rung breadth, and are locked in place.

In a further variation, the sleeving sections on which the rung-hooks are incorporated can be extended and connected by a horizontal section [P8,FIGS. 2a[ii],13a,22b]. {The extended sleeves provide room for footing}. A snap-on mechanism centrally placed on the connecting horizontal section engages with an adjacent extendible fitting on the plating of the attachment device [P8,FIGS. 2a[ii],22b,22a[ii], 22[ii],19a,22[iii]] and the handle [22[iv] is snapped locked. To remove the apparatus, the handle of the mechanism is snapped open, releasing the mechanism allowing the apparatus to be removed.

Other clamping mechanisms and structural organisations of the above can be employed.

This embodiment can be a simple, fixed utilitarian apparatus, as illustrated, [P10,FIG. 2e], or can be modified to provide functions described elsewhere in the description.

FIGS. 2f-2f[ii] illustrate a variation of the above attachment device with retractable rung-hooks, allowing it to be configured at ground level and then to be raised into position and height-adjusted by an operator on the ground.

Horizontally connected, hinged rung-hooks [P11,FIGS. 2f,13a,13,13g,12b] retract through slots in the plating [P11,FIGS. 2f,19,10a,10b] when a line [P11,FIGS. 2f,22g[iii]], hooked over the top ladder rung, attached at 22g,P11,FIG. 2f is pulled upwards, lifting the attachment device of the adjacent ladder rungs. The lower horizontally connected, hinged, rung-hooks [P11,FIGS. 2f,13a,13,13g,12b] can be attached to the upper rung-hooks by an adjustably extendible stay [P11,FIGS. 2f,22g[i],22g[iv]]. The stay [22g[iv]] passes under a hoop [P11,FIGS. 2f,22g[iv]22g[ii]], providing more controlled leverage for retracting the lower rung-hooks. The attachment device and configured apparatus can be lifted into position without obstruction. The rung-hooks are counter-balanced so that when the attachment device is in proximity above the desired position, and the line is abruptly loosened, the rung-hooks swing forward, and engage the adjacent ladder rungs. With further loosening of the line, the configured apparatus settles in place, and can be locked in place.

In this embodiment, the centering device is a turnbuckle attached on the front face of the attachment device [P11,FIGS. 2f,3,3a,] where the centering effect is brought about by the incorporated style-contacting elements, when the turnbuckle is calibrated, contracting to grip the outside edges of the ladder styles [P11,FIG. 2f,P11,FIGS. 2f[i],3d] in response to the turning of the turnbuckle. The tool/accessorisable toolbar attachment locations on either side of the frame [P11,FIGS. 2f,2d[i]] are elongated and holed to allow the passage of the threaded sections of the turnbuckle [P11,FIGS. 2f,2d[i],1b[i],3a].

In addition, the function of the rung-gripping components have been completely integrated/assimilated within the frame of the attachment device. Thus the upper slots on the frame [P11,FIGS. 2f,19,10b] are elongated in which the hinged rung-hooks [13a,13g] slide up or down in the retaining guides [13g[i]] to accommodate ladders with different rung spacings as well as to enable the upper rungs to retract. This arrangement can be inverted with the elongated slots [10b] positioned in the lower section of the frame

As before, the rung-hooks are shaped to accommodate varying rung-breadths.

The dimensions of the rung-hooks, in terms of the distance they project from the attachment device to engage with the ladder rungs, the attachment device, and the fittings that secure the horizontal member, can be optimally gauged to universally accommodate ladders with varying style depths, whilst providing clearance for the horizontal member. This clearance can include an increment to allow for clips which secure the sliding of secondary ladder stages for ladders with maximum style depth.

Expanded sections on the back of the rung-hooks [P11,FIG. 2f,P11,FIGS. 2f,12a] limit the forward action of the retractable rung-hooks, diffuse loading on to the frame from the rung-hooks, and serve as the point of attachment for the horizontal connecting member [12b].

The following drawings [FIGS. 3a-3i,P12-17] illustrate a differentiated, more facilitative and unified embodiment.

FIG. 3a shows a frontal view of the attachment device and tool/accessorisable toolbar unlocked and in the loading position on the front face of a ladder.

FIG. 3b shows a frontal view of the attachment device and tool/accessorisable toolbar locked and in position on the front face of a ladder.

FIG. 3c shows a frontal view of the attachment device with the toolbar in storage position on the front face of a ladder.

FIG. 3d shows a rear view of the attachment device and tool/accessorisable toolbar locked and in position mounted on the front face of a ladder.

FIG. 3d[i] shows a frontal view of the attachment device and tool/accessorisable toolbar mounted on the rear face of a ladder. Figure

FIG. 3e shows a rear view of the attachment device and tool/accessorisable toolbar illustrating a centering mechanism employing spring-loaded intersecting tubing.

FIG. 3f shows a rear view of the attachment device and tool/accessorisable toolbar illustrating a centering mechanism consisting of a system of interconnected elements which expand and contract simultaneously.

FIGS. 3g-3g[ii] show a side view of the rung-gripping components.

FIGS. 3h-3h[iii] show toolbar-to-attachment device engagement fittings.

FIG. 3i shows the attachment device and tool/accessorisable toolbar in position on a ladder with the horizontal assembly in place.

In this embodiment, the rung-gripping components [P12,FIGS. 3a,1,P16,FIGS. 3g,1] are connected to either end of a centering mechanism, such as turnbuckle [P14,FIGS. 3d,1,3,3a,]. The centering mechanism is centrally attached to the attachment device in such a way as to allow it and it's component parts unobstructed movement. Other centering mechanisms are illustrated in P15,FIG. 3e,P15,FIG. 3f. The centering mechanism, a turnbuckle in this case, is centrally attached, with reference to the horizontal plane of the attachment device, to plating [P14,FIGS. 3d,3,3a,19], retained in a centrally attached bracket [P14,FIGS. 3d,3b,3c,]. The said bracket allows the turning of the handle and the movement of the threaded sections [P14,FIGS. 3d,3a], to which the rung-gripping components are attached.

The rung-gripping components are slotted [P12,FIGS. 3a,1,21a,21,P16,FIGS. 3g,1,21a,21]. The slots can be phlanged [P12,FIGS. 3a,21a,21,21b], providing additional support. Plating [P12,FIGS. 3a,19], which can be variously constituted and shaped, is introduced between the slots of the rung-gripping components [P12,FIGS. 3a,1,21a,21,19,P16,FIGS. 3g,1,21a,21,19]. Alternatively, an open frame [P7,FIG. 2a[i]], can be adapted to function similarly.

This arrangement allows the rung-gripping components to move across the plate, engaging and disengaging with the ladder styles, and accommodating ladders of different style widths, in response to the action of the centering mechanism.

The movement of the attached rung-gripping components to engage with the ladder styles in response to the action of the centering mechanism serves to distribute loading maximally over the area of the attachment device and between the ladder styles. The rung-hooks engage the ladder rungs near the ladder styles [P14,FIGS. 3d,1,13,13a], ensuring maximum strength of support.

The rung-gripping components [P12,FIGS. 3a,1,P14,FIGS. 3d,1,13,13a,P16,FIGS. 3g,1,13,13a] in this embodiment have been shaped out of two sections of metal plating [P16,FIG. 3g]. The sections, facing each other and at right-angles to the plating [19] have upper and lower sections removed and shaped to accommodate ladder rungs. As before, the angle that accommodates varying rung breadths on the rung-hooks can travel into the frame to facilitate the passage of the device when attached to and elevated with secondary ladder stages.

As before, if the gap at the widest point of divergence of the rung-hook opening is 7.5 cm or more within the context of practicality, the attachment device can be attached to a range of step-ladders.

To accommodate different rung spacings, in this embodiment, mobile slotted rung-hooks [P16,FIGS. 3g,13b,13c], slide up and down an optimal gap on the rung-gripping components [P16,FIGS. 3g,1,13e] using the slots and guides [P16,FIGS. 3g,13c,13d]. The angle of the sliding rung-hook [13b] accommodates different rung breadths at particular rung spacings. Alternatively, this arrangement can be introduced at the upper rung-hook. [See P16,FIG. 3g[i]].

A fitting [P14,FIG. 3d,P16,FIGS. 3g,18b] can be introduced to engage with a strut, or struts [P16,FIGS. 3i,18] to brace or support a cross-member connecting the arms of a tool/accessorisable toolbar [P16,FIGS. 3i,17]-constituting the horizontal assembly.

The dimensions of the rung-hooks, in terms of the distance they project from the attachment device to engage with the ladder rungs, the attachment device, and the fittings that secure the horizontal member, can be optimally gauged to universally accommodate ladders with varying style depths, whilst providing clearance for the horizontal member. This clearance can include an increment to allow for clips which secure the sliding of secondary ladder stages for ladders with maximum style depth.

The horizontal member, the tool or accessorisable toolbar, is permanently or detachably attached to the attachment device. In this embodiment, a centrally located sleeve [P12,FIGS. 3a,8a] incorporated on the horizontal member [2] is centrally attached to the plating [19]. This can be permanently attached, or have the means, for example, a collar with axel pin and hole sleeving onto a secured spud [P16,FIGS. 3g,8a,8b,8b[i],8c] to make it detachable, or a centrally located clamping mechanism on the plating which releasably clamps the horizontal member in place. Being able to ‘break’ the apparatus into two parts facilitates handling and storage. {The point of attachment of the horizontal member to the plating [19] is central with reference to the horizontal plane of the attachment device to allow the centering effect of the centering mechanism, to which the rung-gripping components are attached in this case, to be effective. The point of it's attachment within the vertical plane of the attachment device is determined by considerations of maximising load-distribution evenly over the area of the device with reference to the positions of the rung-hooks—where the load is applied—and varying rung-breadths. A further consideration can be the provision of room for footing.}

In this embodiment, the sleeve [8a] allows the horizontal member to rotate about it's own axis, the horizontal member being held in place by stops [P12,FIGS. 3a,2,8a,9]. {Where a clamping mechanism is used, it allows the horizontal member to rotate about it's own axis.}

The angle at which the arms [P12,FIGS. 3b,14] project within the vertical plane of a standing ladder as a result of this rotational capacity can be set by aligning appropriate holes provided in the horizontal member [P12,FIGS. 3a,15a] with each hole in the locking sleeves, and securing that position using a pin [P12,FIGS. 3b,2,2a,15,15a]. Additional holes in the horizontal member can be provided for particular functions which can correspond with the use of different accessories e.g. roof-ridge attachment, base stabiliser.

Rotation in the vertical plane of a standing ladder can be provided by pivotally attaching the sleeve [8a] to the plating [P12,FIGS. 3a,8a,8c,19,P16,FIGS. 3g,8a,8b,8c].

Parellel fixings on the plate, raised slotted phlanges [P12,FIGS. 3a,19,20,20a], engage plating incorporated on the locking sleeves [P12,FIGS. 3a,2a,P16,FIG. 3h,P16,FIG. 3h[i],P16,FIGS. 3h[ii]2a,2c,19,20,20a], which can be secured using a pin and hole system [P12,FIGS. 3b,15,P16,FIGS. 3h,15]. The two sets of parellel fixings, in this embodiment, enable the horizontal member to be secured in the horizontal and vertical plane of the attachment device.

In the present embodiment, [P12,FIG. 3a], the horizontal member is secured employing the same combination of locking sleeves [2a], pin and hole [15,15a], sliding sleeves [2b] spring-button [16] as in the first embodiment [FIGS. 1a-1h] allowing partial or full rotation.

Other means of securing the horizontal member to perform the above functions fall within the scope of the invention.

In operation this embodiment functions similarly to the first embodiment, with the addition of the rotation of the horizontal member in the vertical plane of a standing ladder with fittings to secure it in selected positions

The partial rotation, for easier handling, of the tool/accessorisable toolbar enables the apparatus to be fitted on a ladder in situe, with the tool/toolbar arms [P12,FIGS. 3a,14] resting on a vertical surface [P12,FIG. 3a]. With the attachment device secured, the top of the ladder can be lifted of the surface by the operator on the ground. The arms [14] will drop down into position [P12,FIG. 3b], determined by the stopping action of the remaining sections of the excised locking sleeves [P12,FIG. 3b] and the pin and hole system [P12,FIGS. 3b,15,15a]. The lower part of the ladder is pulled out, and the ladder, the device and tool/accessorisable toolbar are then in place.

This arrangement is configured so that when the arms drop down and the bottom of the ladder is pulled out, the ladder and device are set at an angle of 75 degrees to the wall, the arms projecting at approximately right-angles to the wall. The angle of projection can be simply varied using different positions of holes in the horizontal member [2] with reference to the holes in the locking sleeves [2a] and the pin and hole system [P12,FIGS. 3b,15,15a], as when the apparatus is accessorised as a base stabiliser.

By sliding sleeves [P12,FIGS. 3a,2b], shaped to intersect with the locking sleeves, [P12,FIG. 3a,P12,FIGS. 3b,2a], into position, the tool/toolbar is prevented from rotating, locking it in that position [P12,FIGS. 3b,2a,2b The sleeves [2b] are stopped in position by spring-loaded buttons [P12,FIG. 3a,P12,FIGS. 3b,16]. The horizontal assembly [P17,FIGS. 3i,17,17a,18,18a], once in place, acts to support or brace a particular configuration.

After use, the sliding sleeves [2b] are disengaged, the ladder is raised, the arms rest on the surface at this raised point so that when the ladder is dropped down, the arms, now free to rotate, stay at this point, allowing the top of the ladder to rest on the surface. The tool/accessorisable toolbar, if detachable, or the tool/accessorisable toolbar and attachment device can then be detached and removed from the ladder.

Alternatively when the toolbar takes the form depicted in P17,FIG. 3i, with the horizontal assembly [P17,FIGS. 3i,17,18] removed, and sleeves [P12,FIGS. 3a,2b] disengaged from the locking sleeves [P12,FIGS. 3a,2a], the toolbar and arms [14a] can be swung back, the arms folded along the length of the toolbar. With the two locking sleeves [2a] disengaged from the slotted phlanges [20,20a], the toolbar and folded arms can then be rotated and locked in a vertical position [P13,FIG. 3c], employing the horizontal slotted phlanges [20,20a] and the locking sleeves [2a]. The apparatus can be left in situe, or removed. This facilitates transport, storage and handling, on and off the ladder. The reverse sequence of actions readies the device and tool/accessorisable toolbar for use.

The attachment device, in this case, is releasably secured using a hinged, adjustable quick release mechanism [P14,FIGS. 3d,22a,22].

FIGS. 4-4c[P18-20] illustrates a variation where the movement of the rung-gripping components in response to the action of the centering device is guided and contained within a box frame.

FIGS. 4d-4d[ii][P21] shows an alternative guiding system for the movement of the rung-gripping components and means for rotating the tool/accessorisable toolbar.

FIG. 4a shows a frontal view of the attachment device and tool/accessorisable toolbar in position.

FIG. 4a[i] shows the attachment device and tool/accessorisable toolbar in storage position, on or off a ladder.

FIG. 4a[ii] shows the attachment device and tool/accessorisable toolbar with an alternative rung space accommodating and locking mechanism.

FIG. 4b shows an exploded rear view of the attachment device and tool/accessorisable toolbar.

FIG. 4c shows a profile of the attachment device and tool/accessorisable toolbar.

FIG. 4d shows a frontal view of an alternative guiding system for the movement of the rung-gripping components and means for rotating the tool/accessorisable toolbar.

FIG. 4d[i] shows a profile of the tool/accessorisable toolbar attachment fittings to the attachment device.

FIG. 4d[ii] shows a rear view of the alternative guiding system for the movement of the rung-gripping components and means for rotating the tool/accessorisable toolbar.

FIG. 4e shows an embodiment where the attachment device has retractable rung-hooks.

FIG. 4e[i] shows a variation of the above embodiment which functions in the same way where the retractable upper rung-hooks are reversed.

FIG. 4e[ii] shows an arrangement of the apparatus with retractable rung-hooks with rung-gripping components modified to accept the struts of the horizontal assembly in a position that facilitates the passage of the apparatus with configured horizontal assembly when elevated.

FIG. 4e[iii] shows a profile of the above.

P20,FIG. 4b shows the rung-gripping components [1], connected to a centering mechanism [24] fixed centrally [8c] [with respect to the horizontal] to a box frame [28] which contains and guides the movement of the rung-gripping components [1] in response to the centering mechanism and provides a rigid support frame for the centrally attached tool/toolbar [8c,2].

The rung-gripping components are sliding intersecting tubing [P20,FIG. 4b,P20,FIGS. 4c,1,27,26,] incorporating rung-hooks [13,13a]. The intersecting tubing [27,26] accommodates varying rung spacing, the rung-hooks [13,13a] varying rung breadths. An extended phlange on the lower tubing [P20,FIGS. 4b,29,27] has two slots [P20,FIGS. 4b,29b,29c]. One end on one side of the centering device [P20,FIGS. 4b,24a] is fixedly attached to the lower slot [29c], the other end [24b] engages with the slot, being able to slide in the slot. This arrangement allows the rung-gripping components to move equi-distantly to and from the centre of the device, ensuring the symmetry of placement of the attachment device, and extending and contracting to accommodate ladders with varying style widths.

The upper sleeved tubing [P20,FIGS. 4b,26] has a fitting [29a] which engages with the upper slot [FIGS. 4b,29b] of the extended phlange [29] attached to the lower tubing [P20,FIGS. 4b,27], and can slide within the slot. This arrangement allows the sliding action of the tubing [27,26] with incorporated rung-hooks, to accommodate varying rung spacing while keeping the tubing together. This can be carried out by other means.

As before, diverging rung-hooks accommodate varying rung breadths and if the gap at the widest point of divergence of the rung-hook opening is 7.5 cm or more within the context of practicality, the attachment device can be attached to a range of step-ladders.

Shaped spacers [13f] can be introduced on the style-contacting faces of the rung-gripping components [1] and for the rung-hooks, for solid or hollow walled ladders, to allow the passage of clips securing secondary ladder stages. This provides unobstructed movement when the apparatus is elevated with secondary ladder stages and uniform contact with ladder styles.

The dimensions of the rung-hooks, in terms of the distance they project from the attachment device to engage with the ladder rungs, the attachment device, and the fittings that secure the horizontal member, can be optimally gauged to universally accommodate ladders with varying style depths, whilst providing clearance for the horizontal member. This clearance can include an increment to allow for clips which secure the sliding of secondary ladder stages for ladders with maximum style depth.

As before, an extension to the distance that the rung-hooks project from the attachment device to the rungs is built in [P20,FIGS. 4c,13,x-y] to optimise the accommodation of varying ladder style depths.

The centering mechanism, in this embodiment, comprises a series of interconnected, hinged elements [P20,FIG. 4b] which extend and contract equi-distantly from it's centre point. The mechanism is connected at it's centre point to the centre of the inside of the box frame [P18,FIGS. 4a,8c], with reference to the horizontal plane of a standing ladder, allowing the interconnected hinged elements and the attached rung-gripping components to move independantly of the box frame and the attached horizontal member. The rung-gripping components fit snugly in the box frame, but move freely in response to the action of the centering device. This arrangement provides the attachment device with a useful coherency.

Slots in the front face of the box frame [P18,FIG. 4a[i],P18,4a,[ii],P19,4b,28,28a] allow access to the rung-gripping components to move them to engage and disengage with ladder styles. This can also be accomplished by introducing grips on each rung-gripping component, making them easy to manipulate. The attached centering mechanism is capable of expanding and contracting to accommodate varying ladder style widths. A quick-release locking mechanism [P20,FIGS. 4b,30,30a] secures the centering mechanism, keeping the attachment device in place, preventing sideways movement.

A hinged, adjustable quick-release mechanism [P20,FIGS. 4c,22,22a] secured to the back face of the box frame keeps the attachment device in place, in this embodiment.

Other mechanisms can be employed to perform these functions.

The horizontal member is centrally attached, with respect to the horizontal, permanently or detachably, to the box frame [P18,FIGS. 4a,2,28], it's centre corresponding with the centre of the centering device. As in the above embodiments, an incorporated pivoting sleeve retained by stops [P18,FIGS. 4a,9,[8a]], allows the horizontal member [2] to rotate about it's axis, and in the vertical plane of a standing ladder. Fixings on the horizontal member and the attachment device, as previously described, serve to secure the tool/accessorisable toolbar in various configurations [P18,FIG. 4a,FIG. 4a[i]].

As in previous embodiments the horizontal member can take the form of an accessorisable toolbar [P4,FIGS. 1f,1f[i]] and can be braced or supported by the horizontal assembly [P17,FIGS. 3i,14,14e 17,17a,18,18a,2,].

P18,FIG. 4a[ii] shows an adaption of P8,FIG. 2a[i] incorporating features of the present embodiment.

In this variation, the rung-gripping components are single tubing [P19, FIGS. 4a[ii],1], with permanently attached rung-hooks on the lower sections [P19,FIGS. 4a[ii],1,13]. Horizontally extendibly connected [22b,22b[i]], reversed upper rung-hooks [13a] are sleeved on to the rung-gripping components. The horizontally extendibly connected upper rung-hooks also sleeve centrally on to tubing [22c] stemming from the box frame [28]. When the attachment device is placed on a ladder, the upper rung-hook assembly [P19,FIGS. 4a[ii],13a,22b[i],22b,22d] is moved into contact with the underside of the ladder rung, and the intersecting tubing [P19,FIGS. 4a[ii],22b,22c,22d] locked in position. The attachment device is then secured.

P21,FIG. 4d shows a variation of the apparatus whereby the horizontal member takes the form of a intersecting tubing [P21,FIGS. 4d,2[i],2[ii],2[iii]], where tubing sections 2[i] and 2[iii] are attached to a rung-gripping component P21,FIGS. 4d,2[i],2[iii],1,2d[ii]. Tubing section 2[iii] sleeves snugly on to tubing section 2[ii] which is attached to tubing section 2[i]. The rung-gripping components are slotted into which slots are introduced plating [P21,FIGS. 4d,1,19a,P21,FIGS. 4d[i],1,19a]. The rung-gripping components are connected employing a centering mechanism [P21,FIGS. 4d[ii],1,24] which is centrally [with respect to the horizontal] attached to the plating [P21,FIGS. 4d[ii],19a,24].

Thus when the rung-gripping components extend or contract to accommodate ladders with varying style widths, the attachment device is symmetrically positioned.

As the rung-gripping components extend and contract, the horizontal member extends and contracts, the accommodation taking place in the sleeving action of the tubing sections [P21,FIGS. 4d,2[i],2[ii],2[iii]].

Tubing sections 2[i] and 2[iii] are connected to the attachment device by a fitting, 2d[ii], attached to the rung-gripping components [P21,FIGS. 4d,2[i],2[iii],1,2d[ii]] wherein a pin and hole system [P21,FIGS. 4d,2d[ii],15,P21,FIGS. 4d[i],2d[ii],15] corresponding with selected holes in each of the tubing sections 2[i] and 2[iii], once engaged, locks the horizontal member in a selected orientation. The sleeving action of the horizontal member allows each tubing section to rotate freely about it's axis. Blocks located on either side of the tubing sections at their point of attachment [P21,FIGS. 4d,2[i],2[iii],2d[ii],2[v]] keep the tubing sections in place. The said pin and hole system of the fitting, 2d[ii], locks each tubing section in selected positions. Different positions can be provided by introducing selected calibrated holes into each of the tubing sections where they are located in the fitting, 2d[ii].

The upper rung-hooks are horizontally connected by sleeving sections [P21,FIGS. 4d,22b,22b[i]]. Sections 22b[i] are sleeved on to the rung-gripping components [P21,FIGS. 4d,1,22b[i]]. The horizontal sleeving [P21,FIGS. 4d[ii],1,22b,22b[i]] accommodates the extension and contraction of the rung-gripping components.

Sleeving section 22b sleeves in to tubing 22c which is centrally attached to the plating [P21,FIGS. 4d[ii],22b,19a,22c,22c[i],22c[ii]]. This latter sleeving action accommodates ladders with varying rung spacing as well as allowing disengagement of the upper rung-hooks. The attachment device is locked on to the ladder by moving the upper reversed rung-hooks to engage with the underside of the adjacent rung and are fixed in position by locking sleeving section 22c onto section 22b using locking fitting 22d[P21,FIG. 4d[ii]].

Similarly, horizontal travel of the rung-gripping components can be prevented by locking tubing section 2[iii] on to tubing section 2[ii] using a locking fitting 2[iv]-P21,FIG. 4d.

A variation of the above can be where the mid-section of the horizontal member is simplified, by being converted into a turnbuckle mechanism, thereby replacing the existing centering mechanism.

P22,FIG. 4e shows an embodiment where the attachment device has retractable rung-hooks [P22,FIGS. 4e,13a,13g,13h], enabling the attachment device and tool/accessorisable toolbar to be pulled up, and height-adjustable on, a ladder without obstruction, by a line attached at 22g,P22,FIG. 4e, and hooked over the top rung, for example, by an operator on the ground

In this embodiment, the intersecting rung-gripping components [P22,FIGS. 4e,1,26,27] are slotted [26,26[i],27,27[i]] to accommodate the hinged rung-hook [13a,13g] when they retract. Their sleeving action allows accommodation for ladders with varying rung spacing.

The rung-gripping components are connected by a centering device centrally attached to the box frame [P22,FIGS. 4e,1,24,28], which, as before, can expand and contract to accommodate ladders with varying style widths, ensuring symmetry of placement, and maximum uniform load distribution over the device, and between the ladder styles.

To retract the rung-hooks, a line, hooked over the top rung of a ladder, is attached to extendible intersecting tubing [P22,FIGS. 4e,22b,22b[i],22g] which connects the upper rung-hooks. This extendible intersecting tubing, which is hingedly attached to each rung-hook [P22,FIGS. 4e,13,13a,13g,13h] is sleeved on to the mid-section tubing which is attached centrally to the box frame [P22,FIGS. 4e,28,22c]

When the line, attached at FIGS. 4e,22g, is pulled, the extendible intersecting tubing [22b,22b[i]], with the attached upper retractable hinged rung-hooks, [13a,13g,13h,] slide up the mid-section tubing [22c]—the upper rung-hooks are incorporated on tubing sleeving into tubing in the lower section of the attachment device [P22,FIGS. 4e,26,27], so are free to move. As this happens, the rung-hooks lift off the rung. The extendible intersecting tubing [22b,22b[i]] with the attached upper retractable rung-hooks, [13a,13g,13h,], is stopped by the cap [22f[ii]] when it reaches the top of tubing section, 22f.

Tubing section 22f is pinned [22f[i]] and hingedly attached to an irregularly slotted spigot [P22,FIG. 4e,A,B,C 22c[i],22c[ii]] terminating tubing section [22c[i].

The sleeving [P22,FIGS. 4e,22b] with intersecting tubing, [22b[i]] fits on to section 22f and is stopped by the cap [22f[ii]]. The sleeving [P22,FIGS. 4e,22b] with intersecting tubing, [22b[i]] then travels with the section 22f to the top of the irregularly slotted spigot [P22,FIG. 4e,C].

At this point, the said sleeving [22b] with intersecting tubing [22b[i]] can freely hinge.

Further pulling of the line causes sleeving [22b] with intersecting tubing [22b[i] to hinge outwards bringing with it the attached hinged upper rung-hooks, now disengaged from the ladder rung, causing them to retract through slots [26[i]].

At this point, the tubing, [22c[i]], is pulled up through the sleeving [22c] joined to the box frame [28] causing the lower rung-hooks [13] to lift off the ladder rung.

The lower rung-hooks [P22,FIGS. 4e,13] are connected with intersecting tubing, as above, [P22,FIGS. 4e,27,13,13g,13h,22b[i],22b] which is attached to the lower end of mid-section tubing [22c[i]] by chain link [22h]. The chain link can be replaced with wire or cord, for instance. The chain link is attached to a hoop on the intersecting tubing [P22,FIGS. 4e,22h,22g,22b,22b[i]]

Further pulling of the line causes the lower intersecting tubing [P22,FIGS. 4e,22b,22b[i]] with the attached, hinged lower rung-hooks [P22,FIGS. 4e,27,13,13g,13h] to hinge outwards away from the front face of the ladder, made possible by the angle of projection of the loop, and the flexibility of the chain link. This causes the lower rung-hooks to retract through slots [27[i].

The attachment device and tool/accessorisable toolbar can then be pulled up a ladder, or lowered, to a selected location without the obstruction of the projecting rung-hooks.

To position the attachment device and tool/accessorisable toolbar, it is pulled above, or lowered to, the selected adjacent rungs, the line is slackened abruptly, and the lower rung-hooks [13], either counterbalanced or spring-loaded to swing forward into position, ‘catch’ and engage with the selected rung as the sleeved tubing [22c[i]] descends, slackening the chain link and returning the intersecting tubing, which in turn returns the retractable rung-hooks.

The intersecting tubing [22b,22b[i]] can similarly be counterbalanced or spring-loaded causing the upper retracted rung-hooks to return, engaging with ladder rungs.

The attachment device and tool/accessorisable toolbar is now resting on the lower rung-hooks which are engaged by a ladder rung at the selected position.

With further slackening of the line, the intersecting tubing [22b,22b[i]] connecting the upper rung-hooks, slides of the hinged section [22f] and down the mid-section tubing [22c].

{The openings of the tubing [P22,FIGS. 4e,22b] where the intersecting tubing sleeves on to the mid-section tubing [22c] can be widened [P22,FIGS. 4e,22b[ii]] to facilitate engagement with the hinged tubing section [22f] and re-engagement with the mid-section tubing [22c].}

This returns the intersecting tubing and with it, the retracted upper rung-hooks, which project to engage with the appropriate ladder rung. This is accompanied by the intersecting rung-gripping elements [P22,FIGS. 4e,1,26,27] adjusting to the rung spacing.

The attachment device can then be secured using a locking chain [22b[iii] in this case.

P22,FIG. 4e[i] shows a variation of the above embodiment which functions in the same way but where the retractable upper rung-hooks are reversed. When the attachment device and tool/accessorisable toolbar are in position, the lower rung-hooks are engaged by and engage with the adjacent ladder rung, the upper rung-hooks engage the underside of the adjacent ladder rung. The upper rung-hooks are kept in that position by maintaining tension on the line which can be tied off until the upper rung-hooks can be secured in position. This is done by tightening the intersecting tubing [22b,22b[i]], to which they are attached [P22,FIGS. 4e[i],22b,22b[i],13h], on the mid-section tubing [22c], on which the intersecting tubing is sleeved, using a threaded tightening fitting [P22,FIGS. 4e[i],22d]. This arrangement locks the attachment device and tool/accessorisable toolbar on the ladder. The line can then be released.

This arrangement, with retracting rung-hooks, allows various accessorised configurations of the attachment device and tool/accessorisable toolbar, assembled and loaded at ground level, to be positioned on a ladder, or height-adjusted to alter position, with reference to the work area by an operator on the ground.

FIG. 4e[ii],FIG. 4e[iii],P23, shows an arrangement of the apparatus with retractable hooks in place on a ladder. The rung-gripping components have been modified with horizontal extensions located on the lower sections [P23,FIGS. 4e[ii],1,18b]. The supporting struts [18] of the horizontal assembly [P23,FIGS. 4e[ii],17,17a,18,18a] are hingedly attached to horizontal extensions [P23,FIGS. 4e[iii],18,22a,18b]. The supporting struts by being located here provide support while not obstructing the passage of the configured apparatus when elevated.

Other organisations of the apparatus can be variously adapted and modified to function with retractable rung-hooks.

FIGS. 5a-5d show a toolbox for accessories which has components by which it can be converted into a work surface and/or a trestle for accessorising and loading the apparatus on a ladder.

FIG. 5a shows the open toolbox with the dismantled components for a work surface.

FIG. 5b shows the toolbox with the components in position and engaged to form a work surface.

FIG. 5c shows the open toolbox with the dismantled components for a trestle

FIG. 5d shows the toolbox with the components in position and engaged to form a trestle.

A toolbox can be fitted with components to convert it into a work surface [P24,FIG. 5a,P24,FIG. 5b] which can be placed across the arms of the apparatus, when appropriate, providing a useful supported area for the placement of tools and materials when working at height.

Elements centrally hinged inside each lid of the toolbox incorporate and sleeve horizontal tubing [P24,FIGS. 5a,43,44,45,46]. The said elements hinge transversely across each toolbox lid, so that when not in use, they lie flat in the toolbox [P24,FIG. 5a]. Elements pivotally attached to each of the inside panels on which the toolbox lid hinges, [P24,FIGS. 5a,41,42], are of the same length as those elements hinged inside each of the toolbox lids. They are holed to sleeve the horizontal tubing incorporated and sleeved on the elements hinged inside each toolbox lid [P24,FIGS. 5b,46,45,44,43] and pivot across the face of the inside panel to stand vertically at the centre of the panel [P24,FIGS. 5a,42,P24,FIGS. 5b,42]

To construct the work surface, the centrally hinged elements incorporating and sleeving horizontal tubing are moved into the vertical position [P24,FIGS. 5b,43,44,45,46,46a] as are the said pivotally attached elements [P24,FIGS. 5b,42]. The incorporated sleeved horizontal tubing [P24,FIGS. 5a,45,46,46a,P24,FIGS. 5b,45,46,46a] of both the centrally hinged elements [43,44] are moved to engage with each other passing through the holes in the pivotally attached elements [42]. One section of the horizontal tubing sleeves [46] over the other section [46a] and are locked together using a hole-and-spring button mechanism [48a]. Each length of horizontal tubing is held in place where it is sleeved and incorporated on the centrally hinged elements by further hole-and-spring button mechanisms [P24,FIGS. 5b,45,47a+47b]. Thus the toolbox lids are fixed together forming a rigid work surface with two compartments. The connected horizontal tubing serves as a handle. After use, the worksurface can be simply dissembled, the components folded away, leaving adequate space for accessories.

To facilitate loading the attachment device and tool/accessorisable toolbar on the ground where circumstances demand, a toolbox, [FIGS. 5c-5d], can be fitted with components to convert it into a trestle [P24,FIG. 5c,P24,FIG. 5d] on which a ladder can be placed while the attachment device and tool/accessorisable toolbar are configured and loaded, providing convenient access and lifting. Hooked, hinged members [P24,FIGS. 5c,49,49a,49c] on the inside of a hinged, box Lid [P24,FIGS. 5c,40] hinge outwards to engage with fittings on the inside of the opposite hinged box lid [P24,FIGS. 5c,40,49b] when the box lids are partially folded, producing a functional trestle. After use, the trestle can be simply dissembled, the components folded away, leaving adequate space for accessories.

The components for both the trestle and the work surface can co-exist when folded in the toolbox, leaving adequate room for assorted accessories. An attached sling and/or handle make it conveniently portable.

FIGS. 6-8 show the apparatus accessorised with a range of tools.

FIG. 6 shows the apparatus on a ladder with extensions and connecting members to form a

large step-ladders.

FIG. 7 shows the apparatus on a ladder with a hedge-clipping accessory.

FIG. 7[i] shows a profile of where the hedge-clipping accessory is mounted on an arm of the apparatus.

FIG. 7[ii] shows the above location looking down from above it.

FIG. 8 shows the apparatus on a ladder with a roof-ridge accessory.

FIG. 8[i] shows a profile of the roof-ridge attachment.

FIG. 8[ii] shows a hinged fitting on a foot-grip on the roof-ridge accessory.

In the drawing [P25,FIG. 6], extensions [6a] joined by a cross-member [6b], which is centrally connected to a ladder [6c], are mounted [14e] on either arm [14a] of the accessorisable tool bar [P25,FIGS. 6,6a,6b,6c,14a,14e]. The arms of the apparatus [14a] can project variously downwards and away from the ladder and locked in position. The extensions and the connecting members [P25,FIGS. 6,6a,6b,6c,] can be adjustably extendible Surface-gripping tools [14f] are mounted on either end of each extension. The said tools can be used to accessorise the apparatus as a base or stand—of stabiliser. The extensions and the connecting members, which can be calibrated to conform to various configurations, and the said tools can be mounted variously including using sleeving with pin-and-hole or spring-button-and-hole fittings and clamping mechanisms.

In FIG. 7,P25, a hedge-clipping accessory, which is a light-weight frame [7] with a large area which can be netted or webbed, is mounted on the apparatus in position on a the ladder. The large area of the frame diffuses the load, which is primarily the weight of the operator transmitted by the apparatus to the frame, on to the hedging material without causing significant damage. Frames with varying areas can be more appropriate for different hedging material. Beneficially, the frame can be concave facing into the hedging material. The frame is filled out using a light-weight material such as netting or webbing, which, if slackly attached produces a useful ‘give’ in the interface of hedge and frame. Such a load-diffusing frame can be adapted for use on delicate surfaces such as slating or glass, where the surface-contacting face of the frame is beneficially rigid with a pliable layer, such as foam rubber. This can be readily carried out by attaching a rigid, foam-covered, preferably lightweight, structure using a system of clips to the frame. A load-diffusing frame of this type can be usefully employed on weak-structures such as bill-boards.

A hedge-clipping accessory can be variously mounted on the arms of the apparatus using, for example, hinged and holed sections of tubing attached mid-section to each vertical side of the frame [P25,FIGS. 7[i],7a,22a] which sleeve on to the ends of each arm [P25,FIGS. 7,7a,14e,14a,P25,FIGS. 7[i],7a,22a,14e,14a], where a spring-button engages with the hole in the hinged section of tubing [P25,FIGS. 7[i],7[ii],22a,14e,14a]. This arrangement can be supported by the horizontal assembly [P5,FIGS. 1g,17,17a,18,18a,] which, with it's overall adjustable extendibility in conjunction with the rotation of the tool bar about it's axis, allows the angle at which the frame projects against hedging material to be varied and locked.

Further adjustability can be obtained by attaching a length of tubing mid-way to either side of the frame, such that when mounted the tubing will accommmodate the arms of the apparatus when fully extended and at an optimally wide angle. Fittings that hinge in line with the tubing and can be detachably mounted on the ends of the arms are sleeved permanently

on the said tubing between it's attachment points. The attachment points of the tubing can be set out from the sides of the frame towards the ladder to allow the tubing to accommodate any looseness if materials such as netting or webbing are used. The tubing can be calibrated to accommodate the shortening or lengthening of the arms, which will move along the tubing, via the sleeved mounted fittings, towards and away from the centre such that the frame is always in a fixed and selected position. This can be effected by introducing spring-loaded buttons along the length of the tubing, which can either lock the sleeved mountings by engaging adjacent holes in the sleeved mountings, preventing the frame from rotating, or by preventing the sideways movement of the tubing and frame. In this latter case the buttons act as blocks to movement on either side of the sleeved mountings, allowing rotation of the frame. Because they can be depressed, the arms via the sleeved mountings, can adjustably move in response to their lengthening or shortening, whether by actual length adjustment or the adjustment of their angle of divergence.

For taller hedging material, the apparatus shown in FIG. 4e[ii],P23, or variations of it, with the horizontal assembly in place, may be of greater use.

A roof-ridge accessory is shown [P26,FIG. 8] mounted on a variation of an accessorisable tool bar, which allows a shorter distance between the arms. Alternatively, the roof-ridge accessory can be incorporated on a shortened toolbar which integrated with the horizontal member can be detachably mounted on the attachment device, effectively becoming an individual integrated accessory tool.

Incorporating accessories on a shortened toolbar which can then be mounted detachably on the attachment device have advantages in some applications. Alternatively the accessorisable toolbar can have removable sections, enabling the arms to be placed closer together, where the arms are attached to sections which share the same fittings as the removable sections, making the length-adjustment of the toolbar convenient. FIGS. 8a-8c,P26 illustrate an accessorisable toolbar with this capability, making use of the existing fittings.

The roof-ridge accessory comprises, in this embodiment, a hoop with a hinged wedge-shaped foot-grip mounted on each arm [P26,FIG. 8,b,P26,FIGS. 8[i],b,c,a] of the accessorisable toolbar. With a line tied to a central loop on a cross-member {from the horizontal assembly}

that connects each hoop [P26,FIGS. 8,b,17a,17,17g] the roof-ridge accessory, being able to rotate, partially in this configuration, with the accessorisable toolbar, can be pulled back and secured from the ladder base. This allows a ladder to be maneuvered into position on a roof with out it's obstruction. When in position the line can be loosened from the base of the ladder and the roof-ridge accessory lowered into position. When the work is finished, using the line, the roof-ridge accessory can be raised away from the roof-ridge and secured in the raised position. Because it partially rotates with the accessorisable toolbar, when the roof-ridge accessory is raised by pulling the line form the ladder base, the position at which the rotation is stopped is such that when the line is released, the roof-ridge accessory will drop back into position. This allows the ladder and accessory to be used continually in situe with out the problem of the accessory falling back on the ladder.

The said rotation, partial in this configuration, the hinged, wedge-shaped foot-grips, the are of the hoops, in conjunction with the position of the device on the ladder, means that a ladder can lie flat on an angled roof, being able to accommodate different roof-ridge tile widths without resting on them. This promotes useful load-diffusion. As the ladder does not have to rest on the roof-ridge tiles for the accessory to aquire purchase, the placing of a ladder is made easy, not having to negotiate the roof ridge.

P27 of 29 illustrates an adjustable assembly, which supports or braces an extendible cross-member attached to both limbs, integrated with the attachment device in situe.

P27 of 29,FIG. 9a, illustrates the elements of the assembly integrated with the attachment device more clearly.

P27 of 29,FIG. 9b, shows a rung-gripping component within the above arrangement, with extendible mechanism and sleeving and locking means by which the attachment device accommodates different rung spacings, and is conveniently releasably secured.

P28 of 29,FIG. 9c, shows an organisation of a hinged arm which uses a sliding sleeve [2d]. to intersect with chosen slots [14d[i] on the hinge plate. The sleeve [2d] is locked in place with a spring-loaded button [2[vi]] which affords quick release.

P28 of 29,FIG. 9d shows an organisation of the toolbar, in two separate sections now, which allows shortening through means of a removable sleeve [2[i]a, which sleeves on to section 2[ii]. When this is in place, the toolbar is lengthened. When removed, the toolbar is shortened.

P28 of 29,FIG. 9d[ii] shows the lengthening and shortening effect of the addition or removal of the removable sleeve 2[i]a on the toolbar, where each sleeved or unsleeved section of the toolbar sleeves into tubing fixed onto the attachment device.

P29 of 29,FIG. 9d[iii] shows an arrangement of the attachment device with an alternative means of achieving the same lengthening and shortening of the toolbar. Here each section [modified now] of the toolbar 2[i]bb sleeves into tubing 2[ii]a fixed to the structure containing the reciprocal movements of the rung-gripping components on the attachment device [28]. Modified extensions 2[i]aa sleeve onto the shortened toolbar sections and into the fitting on the attachment device 2[ii]a extending the toolbar.

P29 of 29,FIGS. 9e,9e[i] illustrates a means by which the length of an arm can be adjusted with one hand.

A section of excised tubing [s[i]] is secured via a slot in arm [14a] to the lower end of sleeved tubing [14e]. A spring button [16] on the sleeved tubing [14a] at the lower end engages with one of a series of holes in the sleeving section. By depressing this button [16], the sleeved section can be extended or shortened by pushing or pulling the excised sleeve [s[i]], moving along the slot, and releasing the button to engage a selected hole in the sleeving section.

[P27,FIGS. 9,1a,27d,18e,18b,18d,18c,18,18f,18a,17,17a,14a] illustrates an assembly, which supports or braces an extendible cross-member attached to both limbs, integrated with the attachment device in situe.

Each strut of the assembly pivots through [in this case] being attached to intersecting tubing which sleeves through each of the lower rung-hooks of the rung-gripping components [[FIGS. 9,18a-18e,1a,27d, FIGS. 9b,27d,13].

The struts are detachably connected to sleeved elements which are free to rotate on the extendible cross-member [FIGS. 9,18a,17], via a spring button and hole system on the strut-end and sleeved element respectively.

The struts consist of intersecting tubing whose length can be varied using a spring-button and hole system [FIGS. 9a,18c,18,16]. Further length adjustment is provided by a section of threaded rod which is fixed permanently into the lower section of each strut [FIGS. 9a,18d,18c]. The threaded rod section can be screwed in or out of a threaded section of tubing [18b] attached to intersecting tubing which sleeves through each of the lower rung-hooks of the rung-gripping components [9a,18c,18d,18b,27d,1a]. The lower end of the threaded rod section is adapted to act as a turning means [FIGS. 9,18e]. If the set-up is such that the spring button does not engage with a hole spontaneously, then the above secondary length adjustment provides makes this possible.

The struts can be kept in place while the attachment device is being placed on the ladder, in this example by ‘keepers’ on the ‘box’ [FIGS. 9a,18f,18f]

FIG. 9b illustrates an example of length-adjustable rung-gripping components which together releasably locks the attachment device in situe.

A rung-gripping component consists primarily of a length of box-section which acts as a sleeve for tubing [FIGS. 9b,26b,26c]. The tubing is threaded, into which a section of threaded rod, which is sleeved at it's lower end by tubing to which is attached the lower rung-hook, can be screwed in and out [FIGS. 9b,26c,27c,27b,13], providing adjustability.

The lower end of the threaded rod is ‘stopped’ to retain the lower sleeving in place [FIGS. 9b,27b,27f], and a turning means [27e] fixed to the threaded rod above the lower sleeve allowing free movement, to adjust the length of the rung-gripping component, with reference to varying rung-spacings, and rung breadths, by screwing the section in or out of the threaded tubing. The threaded tubing [26c] sleeves into the boxed section, where a protruding ‘stop’ [26c[i]] ensures uniform movement along the slot [26b[i]] in the boxed section [26b], which limits it's movements [FIGS. 9b,26c, [26c[i], [26b[i]].

A spring button, optimally placed, towards the top of the threaded tubing, to allow for maximum adjustment, engages with a hole in each of the box sections [FIGS. 9,26c,26b,16] which equates with the top of the slot. Thus the lower section of the rung-gripping components, kept in line by the intersecting tubing with attached struts [FIGS. 9b,26c,1a], can be pushed up into the slotted box-sections of the upper section of the rung-gripping component, locking when the respective spring buttons, located at identical positions on each threaded section, engage with each hole, which is located identically on each box-section. This distance remains constant, and provides enough movement so that when the buttons are pressed simultaneously, the lower section slides down, and the lower hooks drop below the rungs, and the apparatus can be removed. The spring button is located such that it remains compressed by and hidden within the box-section, in correspondence to where the slot stops the ‘stop’, facilitating use.

The rung-gripping components are joined at identical points by, in this case, a turnbuckle, which is attached centrally to a ‘box’, [FIGS. 9,26b,26c,3,3c,19] and calibrated to move equidistantly from it's centre, before being attached, at manufacture, to each rung-gripping component. This ensures centrality and therefore symmetry of placement of the attachment device, and therefore attached accessories, resulting from the subsequent dependant movement of the attached rung-gripping components when they make contact with ladder styles contact, which can be mediated by spacers. This movement is brought about by turning the central section of the turn buckle, extending to make contact with the ladder styles, or contracting to loosen for removal of the device.

The ‘box’ contains and guides the movement of the rung-gripping components and is dimensioned horizontally such that the rung-gripping components in conjunction with the turnbuckle can optimally, mutually extend to make contact with the ladder styles, providing universal centrality of placement for the attachment device, and exploiting the support strength associated with rung contact close to the ladder styles. Conversely, the turnbuckle or similar centering means can contract, with associated movement by the rung-gripping components, to optimally accommodate ladders with narrow styles.

Maximum support for the arms is provided through toolbar fixture, through various means, at either horizontal end of the ‘box’ whose structure is necessarily rigid.

### BEST MODE FOR CARRYING OUT INVENTION

The apparatus depicted in FIGS. 9 to 9e represents the most effective expression of the invention to date.

The tool box is opened and emptied of tools: the arms, extensions, extendable cross-member, and in this case the stabiliser attachments. [The storage of accessories is seen as a not insignificant consideration. [See DTI study of Stablisers {UK} pages 62-78]

Initially the ladder will have been placed against the surface to identify where the equipment should be placed.

The tool box, with attached fittings is converted into a trestle [P24/29,FIGS. 5c,5d] onto which the ladder is placed for loading the attachment device at the selected location.

The attachment device is kept locked when not in use for convenience.

By pressing both spring buttons [P27/29,FIGS. 9,16,FIG. 9d[iii]], on each rung-gripping component, the lower section of the device slides down.

The attachment device is place at the selected location on the ladder. The gap between the rung-gripping components is adjusted by turning the turnbuckle to fit the ladder. Shaped spacers can be used to mediate ladder style contact. This is to prevent interference with clips that secure the movement of secondary ladder stages should the apparatus be located on secondary stages, thereby providing easy height variability.

The apparatus is intended primarily to be frontally loading, allowing it to be placed on secondary ladder stages, with the benefits that confers.

The device now in place on the ladder, resting on the trestle, is locked on by pushing the lower rung-hooks, using the intersecting tubing carrying the struts, into the upper rung-hooks [P27/29,FIGS. 9a,1a,18,26c,26b]

Adjustment can be made, turning the adjuster to lengthen or shorten the rung-gripping components [P27/29,FIGS. 9b,27e] until the spring buttons engage with the holes in the box-sections [P27/29,FIGS. 9,26c,26b,16] at which point the opposing rung-hooks, in this case, will be firmly in place.

Further adjustment with the turnbuckle maybe necessary if ladders with hollow-walled styles are being used.

Once these adjustments are made, the attachment device is calibrated for that ladder. A slight loosening of the turnbuckle, and depressing the spring buttons on each of the rung-gripping components, will ‘break’ the attachment device—the lower section slides down, which can be lifted off to be placed in another location, where the initial procedure takes place except without adjustment, or can be ‘locked; for easy handling and storage.

If a ladder with hollow-walled styles is used, the turnbuckle needs several more turns to free the attachment device. Except for this, the attachment device will be calibrated.

Other centering mechanisms can be used. The advantage of turnbuckles is that uniform ladder style contact is made by the rung-gripping components, providing firm placement which is secure, and feels more secure. Confidence is a significant issue in the use of ladders. Only slight contact with the ladder styles is necessary.

At this point, the ladder is resting on the trestle, and the attachment device is in place at the desire location.

Having decided on what application is needed, whether a stabiliser, base or stand-off, or both, or a hedge-clipping accessory, or a roof ridge attachment, or an extension kit for turning ladders into giant step-ladders, which can double as a gap-spanner, and by being split, can act as a roof support for a ladder.

The arms, in this case are separately attached to the attachment device. If the application chosen is as a stand-off stabiliser, the wider the arms are the better, so extensions, as illustrated [P29/29,FIGS. 9d[iii],2[i]aa] are introduced into the fitting [2[ii]a, before the arms are attached.

If a base stabiliser is chosen, a shorter gap between the arms provides greater strength to cope with bottom slippage away from the surface, thus one would exclude extensions.

The arms fit easily into the fittings, there being useful fitting distance before the spring button is depressed to enter the slot on the attachment device fitting [P.29/29,FIGS. 9[iii],2[ii]a].

This slot provides useful free rotation for each arm which can be useful for among other things, mounting accessories on to the attachment device.

The slot in this organisation, stops the arm when it is projecting almost vertically upwards in this loading position, but once in position, the arms will be point towards the surface at approximately right angles.

Another consideration at this point is at what angle should the arms point for maximum effect.

A stabiliser needs optimally diverging arms, widely spaced, a base stabiliser, to prevent outward slippage from the wall, needs maximum strength, so shortened gap between the arms, and arms projecting out at approximately 90 degrees, resting on the ground.

The angle at which the arms project is selected by [referring to P.28/29,FIG. 9c] by moving sleeve [2d] back by depressing spring button [2[iv]]. Thus it disengages with slots [14d[i]] in the hinge-plate [14b], which hingedly connects the arm [14a] to the toolbar. There are a selection of slots [14d[i]] in the hinge-plate which when engaged by the sleeve [2d], determine a particular orientation of the arm. Both hinge-plates are identically slotted.

When the optimum angle for the job is selected, the sleeves [2d] are moved to engage the slots, and locked in position by each spring button [P.28/29,FIGS. 9c,2d,2[vi]].

The attachment device is now in place on the ladder with the arms attached, at a particular angle, at a particular gap, and the accessory is mounted, by way of attached, and maybe hinged sleeving with a hole, which is engaged by the spring button near the end of the arm [P29/29,FIGS. 9e,16,P25/29,FIG. 7,FIG. 7[i]].

If needed the arms length can be adjusted. The extendable cross-member, to accommodate wider arms and divergent angles, connected, and the support struts, adjusted appropriately, are connected. The ladder and apparatus are now ready to be put in place.

### INDUSTRIAL APPLICABILITY

Health and safety legislation is tightening up on the use of ladders in the Uk, limiting them to ‘a no alternative only’ application commercially.

Ladders are regarded as a dangerous tool backed up by significant statistics to that effect. The HSE in the UK is now recommending the use of ladder stabilisers by lone ladder users such as window cleaners and painters and decorators, and has costed the adoption of ladder stabilisers by the working population of which in the Uk there are 3-4 million. About 3 million in the building trade. That is a lot of ladders.

Over the years, people like myself have generated device after device to be attached to ladders, it's almost an industry. They are clearly dangerous when used by themselves. Their operating dynamics and the principles on which their use depends, heavily loading two contact points, set close together when much of the work in which they are used involves large areas, so work is maximised at each ladder placement with subsequent risk-taking, or the necessity to reach around a work area, with subsequent risk-taking.

These experiences and conversations with people less fortunate are the doorway to considering developing something to alleviate these situations, because it was clearly needed, with no significant sign of ladder accessories becoming a perceived necessity, which the evidence strongly indicates. There is a close parellel with car safety belts, and maybe motor bike helmets. Initially there was huge inertia, and then after legislation was introduced, reluctance gave way to felt necessity, by and large. I see an exact parellel with ladder safety devices, with an added consideration. Most people I know who use or who have used ladders do not like using them. They just do not like using them. Quite a few people who I know have had accidents, or know off people who have had accidents using ladders. There seems to be a blind acceptance of the dangers of using ladders, and a set of mores to go with the activity, you just go them and hope for the best. There is a twist to the tale, and that is, if you gave somebody a ladder stabliser who was going to use a ladder, they would baulk at the prospect of having to apply, adjust, maneuver. The prospect of the hassle of it would put them of using it. All you do with a ladder is put it against a wall and climb, it doesn't even seem to matter if it is well placed or not, or how little work can be done relatively safely, or how awkward handling materials are in the presence of obvious danger.

The industrial application whose amelioration I have been aiming to contribute to is to

1. Facilitate the use of accessories by expediting and facilitating their use through simple mechanisms which are easy to use, and produce a good fit, minimising unnecessary ladder movement, using load diffusion over larger areas to combat the tendency to overreach and directing load into the surface in the direction it is applied, outside the reach of the user, access increased areas to work in comfortably, provide a work-surface for convenient tools and materials handling, with reference to the stabilisers. Also to produce a robust product, and make it easy to use, and versatile. This is where the above mentioned added consideration comes in, which amounts to a ‘second wave’.

Seeing accessories almost uniquely in terms of securing the use of ladders, can obscure the very real ready and available access to work at heights that ladders afford. The scenario of ladders being perceived as only part of the solution, the other half being provided by accessories, in a concrete way, seems worth striving for, and seems like a real prospect.

So, having been involved in the above situation, it seemed to me that instead of developing some applications for accessories, and then seeking to make them fit wherever, in the same way as ladders are used to fit the requirements of a particular job, suitable or not, the idea of making a non-specific accessory mounting apparatus, that performs certain basic functions competently, that can be easily configured in different supported ways, with desirable handling characteristics and tool attachment points—a platform—then this ‘platform’ opens the way for designing independant task-specific accessories whose only limitation, beyond bulk and weight, is fitness for purpose and to be able to be attached to the accessory mounting apparatus.

Developing a known universal attachable multi-operational platform, to which designed task-specific accessories are attached, can move the ladder from the dangerous tool category to the really useful tool that, in the right conditions, it is.

1. Releasably securable ladder accessory mounting apparatus, variously attachable to both faces of ladders through means of two horizontally connected pairs of adjustably extendable, vertically [with respect to a standing ladder] aligned, or connected, diverging rung-hooks, incorporating an accessory attachment system comprising a horizontal section with attached arms at either end, with the means to detachably mount adapted ladder accessories, which project divergently into the horizontal plane and where a connecting extendable detachable cross-member can be supported by extendable detachable pivoting struts or extendable detachable stays stemming from the apparatus.

2. As in claim 1 universally fitting including style depth and width, and rung spacing and breadth.

3. As in claim 1 and 2, where the arms can, cojointly or individually, rotate about their horizontal axis allowing the angle at which the arms project into the horizontal in the vertical plane of a standing ladder to be adjusted and secured in position.

4. As in claims 1, 2 and 3, where the arms can, cojointly or individually, rotate about their horizontal axis allowing the angle at which the arms project into the horizontal in the vertical plane of a standing ladder to be adjusted and secured in position, and where selected, secured limited free rotation can occur.

5. As in claim 1, 2, 3, and 4, where the arms can cojointly rotate about a central point, at which point they maybe permanently or detachably mounted, in the vertical field of a standing ladder with fittings to secure selected orientations.

6. As in claims 1, 2, 3, 4 and 5, where the angle at which the arms project into the horizontal field of a standing ladder can be varied and secured in position.

7. As in claims 1, 2, 3, 4, 5 and 6, where the arms are adjustably extendable.

8. As in claim 1, 2, 3, 4, 5, 6 and 7, where the accessory mounting has centering means.

9. As in claim 1, 2, 3, 4, 5, 6, 7 and 8, where by the introduction or removal of spacing means, the distance between the arms can be varied.

10. As in 1, 2, 3, 4, 5, 6, 7, 8 and 9, where the rung-hooks are shaped so that they do not interfere with the ascent or descent of secondary ladder stages to which the accessory mounting is frontally attached, with respect to primary stages, and where enabling spacers are incorporated on their style-contacting faces.

11. Where accessory mounting components are stored in a toolbox which has fittings by which it converts into a work-surface for placing on the mounting when in situe, and a trestle for resting ladders on while loading accessory mounting.

12. Accessory mounting substantially as described herein with reference to FIGS. 1a-9e.
